(19) United States
(12) Patent Application Publication
(10) Pub. No.: US 2025/0048397 A1
(43) Pub. Date: Feb. 6, 2025

(54) METHOD FOR SIDELINK RESOURCE SELECTION, TERMINAL DEVICE, AND STORAGE MEDIUM

(71) Applicant: GUANGDONG OPPO MOBILE TELECOMMUNICATIONS CORP., LTD., Dongguan (CN)

(72) Inventors: Yi DING, Dongguan (CN); Zhenshan ZHAO, Dongguan (CN)

(21) Appl. No.: 18/833,077

(22) PCT Filed: Jun. 17, 2021
(86) PCT No.: PCT/CN2021/100651

§ 371 Date: Jul. 25, 2024

(51) Int. Cl. H04W 72/25; H04W 76/28

(52) U.S. Cl. CPC H04W 72/25; H04W 76/28

(57) ABSTRACT

Provided is method for sidelink resource selection, which is applicable to a first terminal device. And the method includes: selecting at least N transmission resources within a first time range, N being an integer greater than or equal to 1; wherein the first time range comprises an intersection of a link monitoring period and a resource selection period, the link monitoring period being determined based on discontinuous reception (DRX) configuration, and the resource selection period being a time period in which the first terminal device performs resource selection.

### CROSS-REFERENCE TO RELATED APPLICATION

This application is a U.S. national stage of international application No. PCT/CN2021/100651, filed on Jun. 17, 2021, the disclosure of which is herein incorporated by reference in its entirety.

### TECHNICAL FIELD

The present disclosure relates to the field of communication technology, and in particular, relates to a method and an apparatus for sidelink resource selection, a device, and a storage medium.

### BACKGROUND

In sidelink (SL) communication, the terminal device selects transmission resources in the resource pool by sensing. In the case that the receiving end is configured with discontinuous reception DRX, how the transmitting end performs resource selection or resource exclusion needs further study.

### SUMMARY

Embodiments of the present disclosure provide a method for sidelink resource selection, a device, and a storage medium. The technical solutions are as follows.

According to some embodiments of the present application, a method for sidelink resource selection is provided, the method is applicable to a first terminal device, and the method includes:
selecting at least N transmission resources within a first time range, N being an integer greater than or equal to 1;
wherein the first time range includes an intersection of a link monitoring period and a resource selection period, the link monitoring period is determined based on DRX configuration, and the resource selection period is a time period in which the first terminal device performs resource selection.

According to some embodiments of the present application, a method for sidelink resource exclusion, the method is applicable to a first terminal device, and the method includes:
acquiring a set of candidate resources by excluding available resources within a resource selection period, wherein a number of candidate resources within a second time range in the set of candidate resources is greater than or equal to W, W being greater than or equal to 0;
wherein the second time range includes an intersection of a DRX active time period and the resource selection period, the DRX active time period being determined based on DRX configuration, and the resource selection period being a time period in which the first terminal device performs resource selection.

According to an aspect of the embodiments of the present application, a terminal device including a processor and a memory is provided, the memory having a computer program stored therein, wherein the processor, when loading and executing the computer program, is caused to perform the method as defined above.

According to an aspect of the embodiments of the present application, a non-transitory computer-readable storage medium storing at least one computer program is provided, wherein the at least one computer program, when loaded and run by a processor, causes the processor to perform the method as defined above.

According to an aspect of the embodiments of the present application, a chip including a programmable logic circuitry and/or one or more program instructions is provided, wherein the chip, when running on a terminal device, causes the terminal device to perform the method as defined above.

### BRIEF DESCRIPTION OF THE DRAWINGS

FIG. 1 is a schematic diagram of a network architecture according to some embodiments of the present disclosure;

FIG. 2 is a schematic diagram of the physical layer structure of SL communication;

FIG. 3 is a schematic diagram of a time-frequency resource location reservation;

FIG. 4 is a schematic diagram of full sensing resource selection under the full sensing scenario;

FIG. 5 is a schematic diagram of resource selection under partial sensing;

FIG. 6 is a schematic diagram of a DRX cycle and a DRX active period;

FIG. 7 is a schematic diagram of time periods corresponding to various DRX timers;

FIG. 8 is a schematic diagram of a relationship between a selected transmission resource and time periods corresponding to various DRX timers;

FIG. 9 is a flowchart of a method for sidelink resource selection according to some embodiments of the present disclosure;

FIG. 10 is a schematic diagram of resource selection under the full sensing scenario;

FIG. 11 is a schematic diagram of resource selection under the partial sensing scenario;

FIG. 12 is a flowchart of a method for sidelink resource exclusion according to some embodiments of the present disclosure;

FIG. 13 is a schematic diagram of resource exclusion under the full sensing scenario;

FIG. 14 is a schematic diagram of resource exclusion under the partial sensing scenario;

FIG. 15 is a flowchart of another method for sidelink resource selection according to some embodiments of the present disclosure;

FIG. 16 is a schematic diagram of transmission resource selection under the full sensing scenario;

FIG. 17 is a schematic diagram of transmission resource selection under the partial sensing scenario;

FIG. 18 is a block diagram of an apparatus for sidelink resource selection according to some embodiments of the present disclosure;

FIG. 19 is a block diagram of an apparatus for sidelink resource exclusion according to some embodiments of the present disclosure;

FIG. 20 is another block diagram of an apparatus for sidelink resource selection according to some embodiments of the present disclosure; and

FIG. 21 is a structural schematic diagram of a terminal device according to some embodiments of the present disclosure.

### DETAILED DESCRIPTION

To make the purpose, technical solutions, and advantages of the present disclosure clearer, the following describes the embodiments of the present disclosure in detail in conjunction with the accompanying drawings.

The network architecture and the business scenarios described in the embodiments of the present disclosure are used to clearly describe, but not constitute a limitation to, the technical solutions of the embodiments of the present disclosure. And a person skilled in the art knows that, with the evolution of the network architecture and the emergence of new business scenarios, the technical solutions provided in the embodiments of the present disclosure are still applicable to similar technical problems.

Reference is made to FIG. 1, which is a schematic diagram of a network architecture according to some embodiments of the present disclosure. In some embodiments, the network architecture includes: a core network 11, an access network 12, and a terminal device 13.

The core network 11 includes a plurality of core network devices. The core network device provides user connection, user management, and service bearing, and serves as the interface between the bearer network and the external network. In some embodiments, the core network of a 5th generation (5G) new radio (NR) system includes an access and mobility management function (AMF) entity, a user plane function (UPF) entity, an session management function (SMF) entity, and so on.

The access network 12 includes a plurality of access network devices 14. In some embodiments, the access network in the 5G NR system is referred to as a new generation-radio access network (NG-RAN). The access network device 14 is a device deployed in the access network 12 to provide wireless communication functions for the terminal device 13. In some embodiments, the access network device 14 includes various forms of macro base stations, micro base stations, relay station, access points, and the like. In systems employing different wireless access technologies, the device that has the function of the access network device may be named differently, such as, gNodeB or gNB in the 5G NR system. The name of the “access network device” changes possibly as the communication technology evolves. For the convenience of description, the above-described devices that provide wireless communication functions for the terminal device 13 are collectively referred to as access network devices in the embodiments of the present disclosure.

The number of terminal devices 13 is typically more than one, and one or more terminal devices 13 are distributed within a cell managed by each access network device 14. The terminal devices 13 include devices having wireless communication functions, such as hand-held devices, in-vehicle device, wearable devices, computing devices, and other processing devices connected to a wireless modem, and various forms of user equipment, mobile stations (MS), etc. For the convenience of description, the devices mentioned above are collectively referred to as terminal devices. The access network device 14 communicates with the core network device via a specific air technology, such as the NG interface in the 5G NR system. The access network device 14 communicates with the terminal device 13 via a specific air technology, such as a Uu interface.

In some embodiments, a terminal device 13 and a terminal device 13 (i.e., the in-vehicle device and other devices, such as other in-vehicle device, cell phones, road side units (RSUs), and the like) communicate with each other through a direct communication interface (such as a PC5 interface). Accordingly, the communication link established based on the direct communication interface is referred to as a direct link or SL. SL transmission means that communication data is transmitted directly through the sidelink between the terminal devices. Different from the traditional cellular system in which communication data is received or transmitted through an access network device, SL transmission is characterized by a short delay and a small overhead, and is suitable for the communication between two terminal devices in close geographical locations, such as the in-vehicle device and other peripheral equipment that have close geographical locations). It should be noted that in FIG. 1, taking vehicle-to-vehicle communication under a vehicle to everything (V2X) scenario as an example, the SL technology is applied to various scenarios in which communication is directly carried out between terminal devices. Alternatively, the terminal device in the present disclosure refers to any kind of device that communicates based on the SL technology.

In some embodiments, the “5G NR system” in the embodiments of the present disclosure is also referred to as a 5G system or an NR system, and a person skilled in the art understands the meaning thereof. The technical solutions described in the embodiments of the present disclosure are applicable to a 5G NR system or a subsequent evolutionary system of the 5G NR system.

Concerning SL transmission, 3GPP defines two transmission modes: mode A and mode B.

Mode A: The transmission resource of the terminal device are allocated by the access network device (e.g., the base station), and the terminal device transmits communication data over the sidelink according to the transmission resource allocated by the access network device, wherein the access network device either allocates the transmission resource for the terminal device for the single transmission, or allocates the transmission resource for the terminal device for the semi-static transmission.

Mode B: The terminal device selects a transmission resource from the resource pool on its own for the transmission of communication data. Specifically, the terminal device selects a transmission resource from the resource pool by means of sensing, or randomly selects a transmission resource from the resource pool.

The following focuses on SL communication in NR V2X systems, where the terminal devices perform resource selection autonomously (i.e., Mode B above).

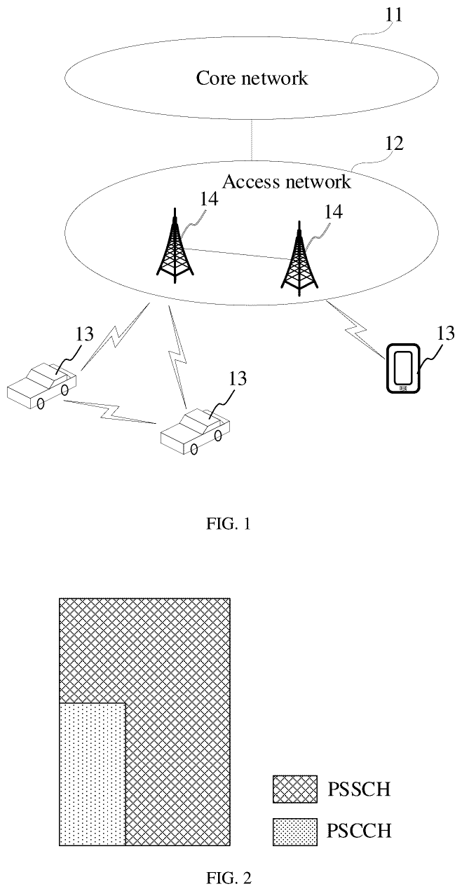

The physical layer structure of SL communication in NR V2X system is shown in FIG. 2. physical sidelink control channel (PSCCH) is used to carry first sidelink control information, and physical sidelink shared channel (PSSCH) is used to carry data and second sidelink control information. The PSCCH and PSSCH are transmitted in the same slot. In some embodiments, the above-mentioned first sidelink control information is functionally different from the second sidelink control information. In some embodiments, the first sidelink control information is carried in the PSCCH, which mainly contains fields related to resource sensing, to facilitate resource exclusion and resource selection by other terminal devices upon decoding. The second sidelink control information is carried in PSSCH in addition to the data, and the second sidelink control information mainly includes fields related to data demodulation, to facilitate other terminal devices to demodulate the data in the PSSCH.

In the NR V2X system, under the above Mode B, the terminal devices autonomously select transmission resources to send data. Resource reservation is a prerequisite for resource selection.

Resource reservation means that the terminal device transmits the first sidelink control information in PSCCH to reserve the resources to be used next. In the NR V2X system, both resource reservation within a transport block (TB) and resource reservation between TBs are supported.

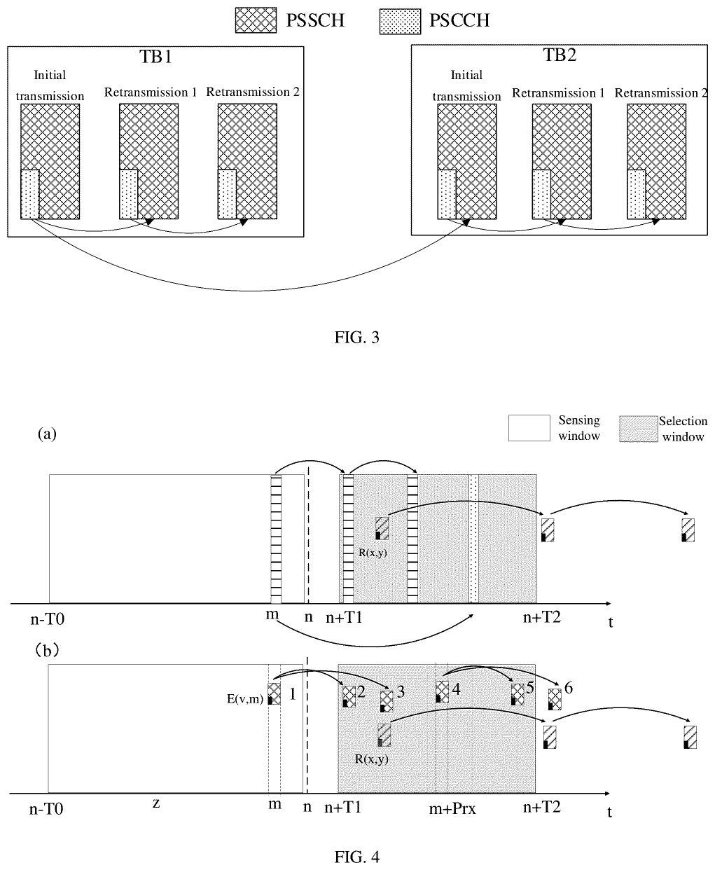

As shown in FIG. 3, the terminal device transmits the first sidelink control information, the “time resource assignment” and “frequency resource assignment” fields therein are configured to indicate the N time-frequency resources of the current TB (including the resource used for the current transmission), wherein N≤Nmax, and in NR V2X, Nmax is equal to 2 or 3. Further, the above-indicated N time-frequency resources should be distributed within W slots. In NR V2X, W is equal to 32. In some embodiments, in TB1 shown in FIG. 3, the terminal device transmits the initial transmission data in PSSCH and simultaneously transmits the first sidelink control information in PSCCH, the above two fields are configured to indicate the time-frequency resource locations for the initial transmission and the retransmission 1 (i.e., at this time, N=2), i.e., reserving the time-frequency resource for the retransmission 1. Moreover, the initial transmission and retransmission 1 are distributed within 32 slots in the time field. Similarly, in TB1 shown in FIG. 3, the terminal device indicates the time-frequency resource locations of retransmission 1 and retransmission 2 based on the first sidelink control information sent in the PSCCH of retransmission 1, wherein retransmission 1 and retransmission 2 are distributed within 32 slots in the time domain.

At the same time, the “resource reservation period” field is configured to reserve resources between TBs when the terminal device sends the first sidelink control information. In some embodiments, in FIG. 3, when sending the first sidelink control information of the initial transmission in TB1, the terminal device utilizes the “time resource assignment” and “frequency resource assignment” fields to indicate the time-frequency resource locations of the initial transmission and retransmission 1 in TB1, which are written as {(t₁, f₁), (t₂, f₂)}, wherein t₁ and t₂ represent the time domain locations of resources of initial transmission and retransmission 1 in TB1, and f₁ and f₂ represent the corresponding frequency domain locations. In the case that the value of the “resource reservation period” field in the first sidelink control information is 100 ms, the sidelink control information (SCI) also indicates the time-frequency resources {(t₁+100, f₁), (t₂+100, f₂)}, which are used for initial transmission and retransmission 1 in TB2. Similarly, through the first sidelink control information sent during retransmission 1 in TB1, the time-frequency resources for retransmission 1 and retransmission 2 in TB2 are also reserved through the “resource reservation period” field. In NR V2X, the possible values of the “resource reservation period” field include 0, 1-99, 100, 200, 300, 400, 500, 600, 700, 800, 900, and 1000 ms, therefore V2X is more flexible relative to LTE (Long Term Evaluation). However, in each resource pool, only e values of these values are configured, and the terminal device determines the values that are possible to be used based on the resource pool used by the terminal device. The e values in the resource pool configuration are marked as a set M of resource reservation periods, and in some embodiments, e is less than or equal to 16.

In addition, in some embodiments, the above reservation between TBs are activated or de-activated by taking the resource pool as unit through network configuration or pre-configuration. In the case that the reservation between TBs is activated, the first sidelink control information includes the “resource reservation period” field. In the case that reservation between TBs is de-activated, the first sidelink control information does not include the “resource reservation period” field. In the case that the reservation between TBs is activated, in general, the value of the “resource reservation period” field used by the terminal device, i.e., the resource reservation period, remains unchanged prior to triggering the resource reselection, and every time the terminal device sends the first sidelink control information, the terminal device utilizes the “resource reservation period” field in the first sidelink control information to reserve the resources for the next cycle of the transmission of another TB, so as to achieve periodic semi-continuous transmission.

In some embodiments, in the case that the terminal device operates under the above mode B, the terminal device acquires the first sidelink control information from the other terminal device by sensing the PSCCH from the other terminal device, thereby learning the resources reserved by the other terminal device. The terminal device excludes the resources reserved by the other terminal devices when performing resource selection, thereby avoiding resource collision.

In the NR V2X system, under above Mode B, the terminal device needs to select resources autonomously.

As shown in FIG. 4, the terminal device triggers resource selection or reselection at slot n, slot n is the slot in which a higher level triggers a physical layer to report a set of candidate resources, and a resource selection window starts from n+T₁ and ends at n+T₂, wherein 0<=T₁<=T_{proc,1}. In the case that a subcarrier spacing is 15, 30, 60, or 120 kHz, T_{proc,1} is 3, 5, 9, or 17 slots. There is T₂ₘᵢₙ<=T₂<=a remaining delay budget of the service, wherein the set of values of T₂ₘᵢₙ is {1, 5, 10, 20} *2^{μ} slots, wherein μ=0, 1, 2, and 3, which correspond to the cases of the subcarrier spacing being 15, 30, 60, and 120 kHz. The terminal device determines T₂ₘᵢₙ from the above set of values based on the priority of the data to be sent by the terminal device. In some embodiments, in the case that the subcarrier spacing is 15 kHz, the terminal device determines T₂ₘᵢₙ from the set {1, 5, 10, 20} based on the priority of the data to be sent by the terminal device. In the case that T₂ₘᵢₙ is greater than or equal to the remaining delay budget of the service, T₂ is equal to the remaining delay budget of the service. The remaining delay budget is the difference between the corresponding moment of the delay requirement of the data and the current moment. In some embodiments, a packet arrived at slot n has a delay requirement of 50 ms, assuming that a slot is 1 ms, then the remaining delay budget is 50 ms in response to the current moment being slot n, and the remaining delay budget is 30 ms in response to the current moment being slot n+20.

The terminal device senses resources during n−T₀ to n−T_{proc,0} (excluding n−T_{proc,0}), with T₀ taking the value of 100 or 1100 ms. In the case that the subcarrier spacing is 15, 30, 60, or 120 kHz, T_{proc,0} is 1, 1, 2, or 4 slots. In fact, in some embodiments, the terminal device senses the first sidelink control information sent by other terminal devices at each slot (except the slot in which the terminal device itself sends data), and the terminal device uses the resource sensing results for n−T₀ to n−T_{proc,0} in the case that resource selection or reselection is triggered at slot n.

Step 1: the terminal device takes all available resources belonging to the resource pool used by the terminal device in the resource selection window as the resource set A. Any resource in the set A is denoted as R(x,y), wherein x and y respectively indicate the frequency domain location and time domain location of the resource. The initial number of resources in set A is denoted as Mₜₒₜₐₗ. The terminal device performs exclusion on the resources in resource set A based on the non-sensing slots in the resource sensing window (Step 1-1) and/or the resource sensing results in the resource sensing window (Step 1-2). The terminal device determines whether resource R(x,y) or a series of periodic resources corresponding to resource R(x,y) overlaps with a slot determined based on the non-sensing slots in Step 1-1 or a resource determined based on the sensed first sidelink control information in Step 1-2, and if they overlap, resource R(x,y) is excluded from the resource set A.

Step 1-1: in the case that the terminal device sends data at slot m within the sensing window without sensing, the terminal device determines, based on the slot m and the each type of resource reservation periods in the resource pool used by the terminal device, the corresponding Q slots by taking the resource reservation periods as intervals. In the case that the Q slots overlap with resource R(x,y) or the series of periodic resources corresponding to resource R(x,y), resource R(x,y) is excluded from the resource set A. The above Q=1 or Q=┌T_{scal}/Pᵣₓ┐ (which is rounding up), wherein T_{scal} is equal to the value of T₂ in milliseconds, and Pᵣₓ is one of the resource reservation periods allowed by the resource pool used by the terminal device.

In some embodiments, in subfigure (a) of FIG. 4, the terminal device does not perform sensing at slot m, and the terminal device performs resource exclusion sequentially based on each of the resource reservation periods in the set M of resource reservation periods in the configuration of the resource pool used by the terminal device. For one of the resource reservation periods with a value of 1, assuming that the value of Q is computed to be 2, the corresponding Q slots are the next two slots identified by the horizontal line shadow in the subfigure (a) of FIG. 4 that are mapped from the slot m at intervals of the resource reservation period 1. For one of the resource reservation periods with a value of 2, assuming that the value of Q is computed to be 1, the corresponding Q slot is the next one slot identified by the dotted shadow in subfigure (a) of FIG. 4 that is mapped from slot m at the interval of resource reservation period 2.

The terminal device determines whether the Q slots corresponding to each type of reservation period overlap with resource R(x,y) or the series of periodic resources corresponding to resource R(x,y), and if they overlap, the terminal device excludes resource R(x,y) from the resource set A.

In some embodiments, in the case that the resource pool used by the terminal device deactivates the reservation between TBs, the terminal device does not perform above Step 1-1.

In some embodiments, upon Step 1-1 being executed by the terminal device, in the case that the number of remaining resources in the resource set A is less than Mₜₒₜₐₗ*X, the terminal device initializes the resource set A to be including all available resources in the resource pool used by the terminal device within the resource selection window, and then executes Step 1-2.

Step 1-2: in the case that the terminal device senses the first sidelink control information transmitted in the PSCCH at the slot m in the resource sensing window, the sidelink reference signal received power (SL-RSRP) of the PSCCH or the SL-RSRP of the PSSCH dispatched by the PSCCH (i.e., the SL-RSRP of the PSSCH transmitted in the same slot as the PSCCH) is measured.

In the case that the measured SL-RSRP is greater than the SL-RSRP threshold and the resource pool used by the terminal device activates the resource reservation between TBs, the terminal device determines, based on the slot m and the resource reservation period carried in the sensed first sidelink control information, the corresponding Q slots at intervals of the resource reservation period. The terminal device assumes that the first sidelink control information with the same content is also received at the Q slots. The terminal device determines whether the resources indicated by the “time resource assignment” and “frequency resource assignment” domains of the first sidelink control information received at slot m and the Q first sidelink control information assumed to be received overlap with resource R(x,y) or the series of periodic resources corresponding to resource R(x,y), and if they overlap, the corresponding resource R(x,y) is excluded from the set A. The above Q=1 or Q=┌T_{scal}/Pᵣₓ┐ (which means rounding up). T_{scal} is equal to the value of T₂ in milliseconds. Pᵣₓ is the resource reservation period carried in the sensed first sidelink control information.

In some embodiments, in subfigure (b) of FIG. 4, in the case that the resource pool used by the terminal device activates the reservation between TBs, in response to the first sidelink control information in PSCCH being sensed by the terminal device at slot m resource E(v,m) and the resource reservation period in the first sidelink control information being Pᵣₓ, assuming that the value of Q is calculated to be 1, the terminal device assumes that the first sidelink control information with the same content is also received at slot m+Pᵣₓ. The terminal device determines whether the resources 1, 2, 3, 4, 5, and 6 indicated by the “time resource assignment” and “frequency resource assignment” fields of the first sidelink control information received at slot m and the first sidelink control information assumed to be received at slot m+Pᵣₓ overlap with the resource R(x,y) or the series of periodic resources corresponding to the resource R(x,y), and if they overlap and the RSRP condition is satisfied, the resource R(x,y) is excluded from the resource set A.

In the case that the SL-RSRP measured by the terminal device is greater than the SL-RSRP threshold and the resource pool used by the terminal device deactivates the resource reservation between TBs, the terminal device only determines whether the resources indicated by the “time resource assignment” and “frequency resource assignment” fields of the first sidelink control information received at slot m overlap with resource R(x,y) or the series of resources corresponding to resource R(x,y), if they overlap, the resource R(x,y) is excluded from the resource set A.

In some embodiments, in subfigure (b) of FIG. 4, in the case that the resource pool used by the terminal device activates the reservation between TBs, in response to the first sidelink control information in the PSCCH being sensed by the terminal device at the slot m resource E(v,m), the terminal device determines whether the resources 1, 2, and 3 indicated by the fields of “time resource assignment” and “frequency resource assignment” of the first sidelink control information overlap with the resource R(x,y) or the series of periodic resources corresponding to the resource R(x,y), and if they overlap and the RSRP condition is satisfied, the resource R(x,y) is excluded from resource set A.

In the case that the remaining resources in the resource set A upon the above resource exclusion are less than Mₜₒₜₐₗ*X, the SL-RSRP threshold is increased by 3 dB, and Step 1 is re-executed. The physical layer reports the resource set A upon resource exclusion as a candidate resource set to the higher layer.

Step 2: the higher level randomly selects a resource from the reported set of candidate resources to send data. That is, the terminal device randomly selects a resource from the set of candidate resources to send data.

The following should be noted.

1. The above RSRP threshold is determined based on the priority P1 carried in the PSCCH sensed by the terminal device and the priority P2 of the data to be sent by the terminal device. The configuration of the resource pool used by the terminal device contains a table of SL-RSRP thresholds, which contains the SL-RSRP thresholds respectively corresponding to all priority combinations. The configuration of the resource pool is network-configured or pre-configured.

In some embodiments, as shown in Table 1, assuming that the optional values of the priority levels of both P1 and P2 are 0-7, the SL-RSRP thresholds corresponding to different priority combinations are denoted by γᵢⱼ, where i in γᵢⱼ is the value of priority level P1 and j is the value of priority level P2.

TABLE 1
Table of SL-RSRP thresholds

P2

| P1 | 0 | 1 | 2 | 3 | 4 | 5 | 6 | 7 |
|---|---|---|---|---|---|---|---|---|
| 0 | γ₀₀ | γ₀₁ | γ₀₂ | γ₀₃ | γ₀₄ | γ₀₅ | γ₀₆ | γ₀₇ |
| 1 | γ₁₀ | γ₁₁ | γ₁₂ | γ₁₃ | γ₁₄ | γ₁₅ | γ₁₆ | γ₁₇ |
| 2 | γ₂₀ | γ₂₁ | γ₂₂ | γ₂₃ | γ₂₄ | γ₂₅ | γ₂₆ | γ₂₇ |
| 3 | γ₃₀ | γ₃₁ | γ₃₂ | γ₃₃ | γ₃₄ | γ₃₅ | γ₃₆ | γ₃₇ |
| 4 | γ₄₀ | γ₄₁ | γ₄₂ | γ₄₃ | γ₄₄ | γ₄₅ | γ₄₆ | γ₄₇ |
| 5 | γ₅₀ | γ₅₁ | γ₅₂ | γ₅₃ | γ₅₄ | γ₅₅ | γ₅₆ | γ₅₇ |
| 6 | γ₆₀ | γ₆₁ | γ₆₂ | γ₆₃ | γ₆₄ | γ₆₅ | γ₆₆ | γ₆₇ |
| 7 | γ₇₀ | γ₇₁ | γ₇₂ | γ₇₃ | γ₇₄ | γ₇₅ | γ₇₆ | γ₇₇ |

In the case that the terminal device senses a PSCCH from the other terminal device and acquires the priority P1 carried in the first sidelink control information transmitted in the PSCCH and the priority P2 of the data to be sent, the terminal device determines the SL-RSRP threshold by Table 1.

2. Whether the terminal device utilizes the measured PSCCH-RSRP or the PSSCH-RSRP dispatched by the PSCCH for comparison with the SL-RSRP threshold depends on the resource pool configuration of the resource pool used by the terminal device. In some embodiments, the resource pool configuration is network-configured or pre-configured.

3. The above X has possible values of {20%, 35%, 50%}. The configuration of the resource pool used by the terminal device contains correspondence between the priority level and the above possible values, and the terminal device determines the value of X based on the priority level of the data to be sent and the correspondence. In some embodiments, the resource pool configuration is configured by the network or pre-configured.

The above introduction is one of the SL communication methods in NR-V2X, i.e., the terminal device autonomously selects transmission resources through resource sensing and autonomously transmits data over sidelink. This SL communication method is also applied to various SL communications such as direct communication between handheld terminals, or direct communication between a pedestrian and a vehicle.

The above-described method of transmission resource autonomous selection by the terminal device through resource sensing does not consider power saving, and the resource selection method based on partial sensing is an energy-saving and power-saving resource selection method designed for power-sensitive terminals, such as handheld terminals, which achieves energy-saving and power-saving mainly by restricting the number of time units for resource selection and the number of time units for resource sensing.

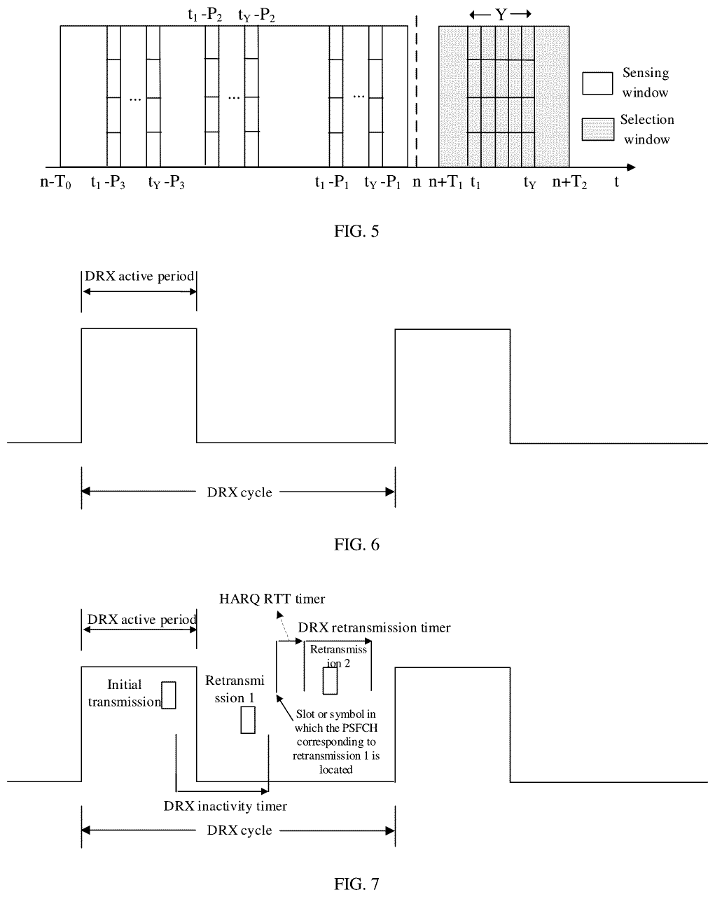

A resource selection method based on partial sensing for SL communications is next described in combination with FIG. 5. The terminal device determines a slot to be sensed within the resource sensing window based on at least Y slots determined within the resource selection window and a set M of resource reservation periods in the resource pool configuration or a subset of the set M. When performing the resource selection, resource exclusion is performed on the at least Y slots described above at least based on the sensing results at the slots and/or non-sensing slots determined within the resource sensing window as described above. In some embodiments, the specific exclusion process is referred to Step 1 described above, and a resource is selected from the remaining resources therein for sending data.

In some embodiments, in FIG. 5, assuming that the terminal device determines a total of Y slots from t₁ to t_{y} within the resource selection window, and the set M of resource reservation periods in the configuration of the resource pool used by the terminal device includes the periods P₁, P₂, and P₃, the terminal device determines, based on each of resource reservation periods in the set M and the Y slots, the sensing slots in the resource sensing window to be t₁−P₁ to t_{y}−P₁, t₁−P₂ to t_{y}−P₂, and t₁−P₃ to t_{y}−P₃. That is, based on the Y slots and each resource reservation period, the slot corresponding to the latest period and belonging to the resource sensing window is determined. When performing resource selection or reselection at slot n, the terminal device excludes resources in the above Y slots at least based on the sensing results at the slots and/or non-sensing slots determined in the above resource sensing window. In some embodiments, exclusion is performed according to Step 1, and ultimately a resource is selected from the remaining resources in the Y slots for sending data.

In some embodiments, in addition to the above-determined sensing slots, the terminal device also performs continuous sensing during [n+T_{A}, n+T_{B}]. In some embodiments, T_{B}=0, T_{A}=−32 slots, a candidate resource set is acquired by performing, based on the determined sensing slots and the sensing results during [n+T_{A}, n+T_{B}] and/or non-sensing slots, resource exclusion on the above Y slots, and a transmission resource is selected from the candidate resource set.

In some embodiments, the mechanism of partial sensing described above is applicable to periodic transmissions, where the location of slot n is predicted based on periods, a resource selection window and a sensing window are determined, at least Y slots are determined from the resource selection window and sensing window, and then the corresponding sensing slots are determined based on the at least Y slots. Sensing is carried out in response to the time proceeding to the sensing slots, and in the case that the time proceeding to the slot n, the resource selection or reselection is triggered, and a transmission resource is selected from the at least Y slots.

In some embodiments, the at least Y slots described above are consecutive slots or non-consecutive slots.

DRX is an energy and power saving method used in uplink and downlink systems, and SL-based DRX mechanisms are also being discussed. The terminal device detects PSCCH and/or PSSCH according to the DRX Cycle configured by a network or pre-configured or configured by other terminal devices. The terminal device detects PSCCH and/or PSSCH during a DRX active period (i.e., ON duration period) in the DRX Cycle (which can be called active state (monitoring state/active state)). In the case that there is no other timer, that drives the terminal device into the active state, being activated during the remaining period of the DRX cycle, the terminal device enters a sleep state. The DRX cycle is periodic, as shown in FIG. 6.

The terminal device determines a basic DRX cycle and an ON duration period therein at least based on sl-drx-Cycle, sl-drx-StartOffset, sl-drx-onDurationTimer, and sl-drx-SlotOffset in the DRX configuration. In some embodiments, a length of the DRX cycle is determined based on the sl-drx-Cycle in the DRX configuration, a start location of the DRX cycle is determined based on the sl-drx-StartOffset, sl-drx-Cycle, and sl-drx-SlotOffset parameters in the DRX configuration, the start location of the ON duration period is consistent with the DRX cycle, and the length of the ON duration period is indicated by sl-drx-onDurationTimer. In fact, the terminal device starts the ON duration timer (i.e., the DRX activity timer in present disclosure) at the start location of the ON duration period, enters an active state to detect the PSCCH and/or the PSSCH, and in the case that the ON duration timer reaches 0, in response to there being no timer that makes the terminal device enter the active state being started, the terminal device enters a sleep state to save energy and power.

In addition to the DRX cycle and the ON duration period described above, at least for unicast, three timers are introduced: the inactivity timer (i.e., the DRX inactivity timer in present disclosure), the HARQ (Hybrid Automatic Repeat reQuest) RTT (Round-Trip Time) timer (i.e., the HARQ RTT timer in present disclosure) and retransmission timer (i.e., the DRX retransmission timer in present disclosure).

In some embodiments, as shown in FIG. 7, in the case that the terminal device detects new data or a new TB or a new MAC (Media Access Control) PDU (Protocol Data Unit) or an initial transmission before the ON duration timer reaches 0, i.e., during the ON duration period, the terminal device starts the inactivity timer, and detects PSCCH and/or PSSCH within the period corresponding to the inactivity timer. In the case that the terminal device detects the retransmission of the same data, i.e., retransmission 1, before the inactivity timer reaches 0, the terminal device determines a slot or symbol in which the physical sidelink feedback channel (PSFCH) corresponding to retransmission 1 is located. In some embodiments, the terminal device determines the slot or symbol in which the PSFCH corresponding to retransmission 1 is located based on the time domain location of retransmission 1 in combination with a mapping relationship. The terminal device feeds, at the PSFCH slot or symbol, an acknowledgement (ACK) or a negative acknowledgement (NACK) to the terminal that sent the retransmission 1. In some embodiments, in the case that there is no timer, that is capable of making the terminal device enter the active state, during the period between retransmission 1 and the PSFCH corresponding to retransmission 1, the terminal device enters a sleep state.

The terminal device starts the HARQ RTT timer after the slot or symbol in which the PSFCH corresponding to retransmission 1 is located, and the terminal device enters a sleep state within the time range corresponding to the HARQ RTT timer, within which time range the terminal device assumes that the terminal that sends the retransmission 1 performs an operation such as preparing data for retransmission. At the time that the HARQ RTT timer reaches 0 or upon the HARQ RTT timer reaching 0, the terminal device starts the retransmission timer and detects the PSCCH and/or PSSCH within the retransmission range, i.e., detects a possible retransmission. The terminal device detects a retransmission of the same data, i.e., retransmission 2, before the retransmission timer reaches 0. Then, the terminal device again determines the PSFCH slot or symbol corresponding to retransmission 2, and again starts the HARQ RTT timer as well as the retransmission timer, and in the case that no retransmission is detected, the terminal device enters the sleep state. Subsequently, the terminal device starts the ON duration timer at the start location of the next ON duration period, and enters the active state.

In some embodiments, upon receiving the initial transmission, the terminal device also determines the PSFCH of the initial transmission, and starts the HARQ RTT timer. At the time of the HARQ RTT timer reaching 0 or upon the HARQ RTT timer reaching 0, the terminal device starts the retransmission timer, and detects the PSCCH and/or the PSSCH during the period corresponding to the retransmission timer.

For a given time point, in the case that the ON duration timer, inactivity timer, or retransmission timer is running, the terminal device needs to detect PSCCH and/or PSSCH.

In summary, the inactivity timer is configured to ensure that the terminal device continues to detect the PSCCH and/or PSSCH for a specific period of time upon receiving new data. The HARQ RTT timer is configured to allow the terminal device to sleep briefly during the period in which the terminal that sends the data processes the data. The retransmission timer is configured to detect the corresponding retransmissions. These three timers are configured separately or simultaneously, and FIG. 7 shows an example of simultaneous configured.

In some embodiments, in the case that the retransmission timer is not used in conjunction with the HARQ RTT timer, it is activated immediately upon reception of the PSCCH and/or PSSCH.

The standard does not currently discuss how the transmitting end should be designed for resource selection or resource exclusion in the case that DRX is configured at the receiving end. Possible designs include adding some constraints for resource exclusion or resource selection in the time domain.

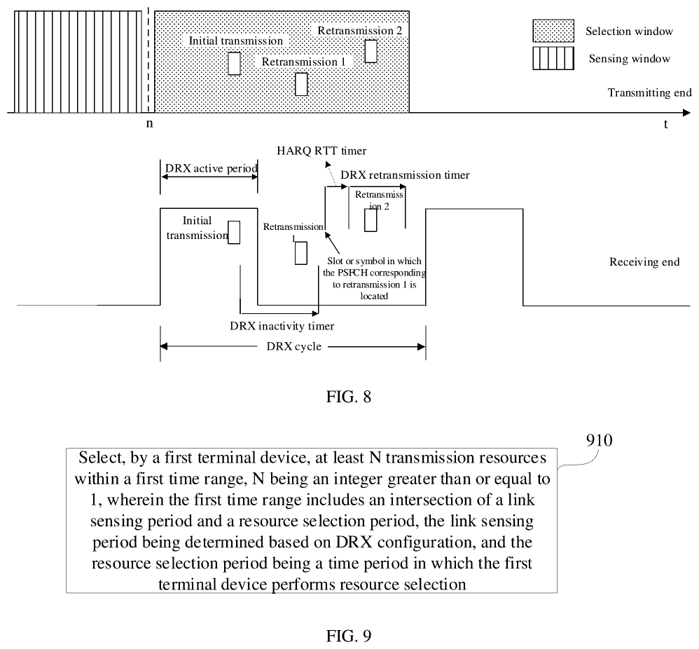

In some embodiments, as shown in FIG. 8, in the case that the transmitting end performs the initial transmission in the ON duration period, performs the retransmission 1 in the range of (the time domain location of the initial transmission, the time domain location of the initial transmission plus the duration of the inactivity timer], and performs the retransmission 2 in the range of (the slot or the symbol in which the PSFCH corresponds to retransmission 1 is located plus the duration of the HARQ RTT timer, the slot or symbol in which the PSFCH corresponds to retransmission 1 is located plus the duration of the HARQ RTT timer plus the duration of the retransmission timer], it can be ensured that the receiving end detects the initial transmission, retransmission 1, and retransmission 2.

However, this resource selection approach is more risky. In some embodiments, as shown in FIG. 8, in the case that the receiving end does not detect the initial transmission, the inactivity timer cannot be activated, and the receiving end enters the sleep state at the end of the ON duration period, and then cannot detect retransmission 1 and retransmission 2, resulting in the failure of the data transmission. In some embodiments, assuming that the receiving end successfully receives the initial transmission, in the case that the receiving end does not detect retransmission 1 within the time range of (the time domain location of the initial transmission, the time domain location of the initial transmission plus the duration of the inactivity timer], the receiving end cannot activate the retransmission timer, and then at the time of the inactivity timer reaching 0 or upon the inactivity timer reaching 0, the receiving end enters the sleep state. Therefore, the communication reliability is reduced because the receiving end only receives the initial transmission from the transmitting end.

The commonality of the above problems is that the receiving end configured with DRX prematurely enters the sleep state due to not detecting the transmission from the transmitting end within the time range of a specific timer (ON duration timer, inactivity timer, or retransmission timer), thereby losing the opportunity to receive more transmissions, resulting in a decrease in communication reliability. The present disclosure proposes optimizations to address this problem.

The technical solutions of the present disclosure are described hereinafter by means of several exemplary embodiments. In addition, before describing the technical solutions of the present disclosure, it is firstly explained that the “DRX active period” mentioned herein refers to the ON duration period described above, which can also be called a continuous monitoring period or other names, which is not limited in the present disclosure. The “DRX activity timer” mentioned herein refers to the ON duration timer described above, which can also be referred to as a continuous monitoring timer or other names, which is not limited in the present disclosure. The “DRX inactivity timer” herein refers to the inactivity timer described above. The “DRX retransmission timer” herein refers to the retransmission timer described above.

Reference is made to FIG. 9, which shows a flowchart of a method for sidelink resource selection according to some embodiments of the present disclosure. The method is applicable in the network architecture shown in FIG. 1. In some embodiments, the method is applicable to any of the terminal devices. In some embodiments, the method includes the following processes.

In process 910, the first terminal device selects at least N transmission resources within a first time range, N being an integer greater than or equal to 1, wherein the first time range includes an intersection of a link monitoring period and a resource selection period, the link monitoring period being determined based on DRX configuration, and the resource selection period being a time period in which the first terminal device performs resource selection.

The first terminal device is any terminal device. In some embodiments, the first terminal device acts as the transmitting end of the SL communication, selects a transmission resource based on the method described in the s prior to transmitting the data to the receiving end, and then transmits the data by using the selected transmission resource. In some embodiments, the first terminal device is in SL communication with one other terminal device or is in SL communication with a plurality of other terminal devices. In this way, the receiving end is one terminal device or a plurality of terminal devices. In the embodiments, the terminal device at the receiving end is referred to as a second terminal device for case of illustration, and it should be understood that the number of second terminal devices is one or more.

The link monitoring period is determined based on the DRX configuration. In some embodiments, the link monitoring period is determined by the first terminal device based on the DRX configuration. In some embodiments, the link monitoring period is a period in which the second terminal device configured with DRX senses the sidelink. The first terminal device determines the link monitoring period based on DRX configuration, wherein the DRX configuration is specifically applicable to a particular second terminal device or is common for a plurality of second terminal devices. In some embodiments, the DRX configuration is configured by a network device, or pre-configured, or specified by a standard, or notified to the first terminal device by another terminal device (such as the second terminal device), or depending on the implementation of the first terminal device.

In some embodiments, the link monitoring period includes at least one of: a DRX active period, a running period of a DRX activity timer, a running period of a DRX inactivity timer, and a running period of a DRX retransmission timer. The DRX active period is equivalent to the running period of the DRX activity timer, and is a partial period of a DRX cycle. The second terminal device is in an active state and detects the PSCCH and/or the PSSCH during the DRX active period/running period of DRX activity timer. The second terminal device activates the DRX inactivity timer upon receiving the initial transmission data (in other words, new data, new TBs, or new MAC PDU), and continues to detect the PSCCH and/or the PSSCH during the running period of the DRX inactivity timer. The second terminal device, upon receiving the initial transmission data or the retransmission data, starts a DRX retransmission timer, and continues to detect the PSCCH and/or the PSSCH during the running period of the DRX retransmission timer.

In some embodiments, the resource selection period includes at least one of: a whole period corresponding to a resource selection window or a partial period determined from the resource selection window. In the case that the first terminal device performs full sensing (or, in the case that the first terminal device does not perform partial sensing, or by default), the resource selection period is the whole period corresponding to the resource selection window. In the case that the first terminal device performs partial sensing, the resource selection period is a partial period determined from the resource selection window. In some embodiments, the resource selection period includes at least Y slots determined by the first terminal device from the resource selection window, wherein the at least Y slots are consecutive slots or non-consecutive slots in the time domain.

In some embodiments, the first time range includes any of the following:
case 1: an intersection in the time domain of the DRX active period or the running period of the DRX activity timer and the resource selection window;
case 2: an intersection in the time domain of the DRX active period or the running period of the DRX activity timer and a partial period (such as at least Y slots) determined by the first terminal device from the resource selection window;
case 3: an intersection in the time domain of the running period of the DRX inactivity timer and the resource selection window;
case 4: an intersection in the time domain of the running period of the DRX inactivity timer and a partial period (such as at least Y slots) determined by the first terminal device from the resource selection window;
case 5: an intersection in the time domain of the running period of the DRX retransmission timer and the resource selection window; or
case 6: an intersection in the time domain of the running period of the DRX retransmission timer and a partial period (such as at least Y slots) determined by the first terminal device from the resource selection window.

In some embodiments, the DRX active period or the running period of the DRX activity timer described above is a time period from start to end of one or more target DRX activity timers determined by the first terminal device based on the DRX configuration. In some embodiments, the target DRX activity timer is determined from one or more candidate DRX activity timers, the candidate DRX activity timer being a DRX activity timer having a running period intersected with the resource selection period.

In some embodiments, the one or more target DRX activity timers described above include: all of the candidate DRX activity timers.

In some embodiments, the one or more target DRX activity timers described above include: H candidate DRX activity timers with foremost time domain locations in the one or more candidate DRX activity timers described above, H being a positive integer. The value of H is configured by a network device, or pre-configured, or specified by a standard, or notified to the first terminal device by other terminal devices (such as the second terminal device), or depends on the first terminal device's implementation. In some embodiments, the DRX active period or the running period of the DRX activity timer is a time period from start to end of a target DRX activity timer that is determined by the first terminal device based on the DRX configuration, and the target DRX activity timer is a candidate DRX activity timer with the foremost time domain location among the one or more candidate DRX activity timers described above, the embodiments can be seen as special cases where H is equal to 1.

In some embodiments, the one or more target DRX activity timers described above include: a candidate DRX activity timer having a longest intersection duration with the resource selection period in the one or more candidate DRX activity timers described above. In some embodiments, the DRX active period or the running period of the DRX activity timer is a time period from start to end of a target DRX activity timer that is determined by the first terminal device based on the DRX configuration, and the target DRX activity timer is a candidate DRX activity timer having the longest intersection duration with the resource selection period in the one or more candidate DRX activity timers described above. In some embodiments, in the case that the number of candidate DRX activity timers having the longest intersection duration with the resource selection period is one, then this one candidate DRX activity timer is the target DRX activity timer; and in the case that the number of candidate DRX activity timers having the longest intersection duration with the resource selection period is multiple, then one candidate DRX activity timer is determined from the plurality of candidate DRX activity timers as the target DRX activity timer, such as randomly selecting a candidate DRX activity timer from the plurality of candidate DRX activity timers as the target DRX activity timer, or identifying a candidate DRX activity timer with the most foremost time domain location among the plurality of candidate DRX activity timers as the target DRX activity timer.

In some embodiments, the running period of the DRX inactivity timer described above is a time period from start to end of the DRX inactivity timer that is determined by the first terminal device based on a duration of the DRX inactivity timer and a time domain location of an initial transmission resource as selected. In some embodiments, the running period of the DRX inactivity timer is (t₁, t₁+t₂] or (t₁, t₁+t₂), wherein t₁ represents the time domain location of the initial transmission resource and t₂ represents the duration of the DRX inactivity timer. In addition, the duration of the DRX inactivity timer described above (i.e., the value of t₂) is configured by a network device, or pre-configured, or specified by a standard, or notified to the first terminal device by other terminal devices (such as the second terminal device), or depends on the implementation of the first terminal device.

In some embodiments, the running period of the DRX retransmission timer described above refers to a time period from start to end of a DRX retransmission timer corresponding to a target transmission resource as selected that is determined by the first terminal device based on the duration of the DRX retransmission timer and a time domain location of the target transmission resource. In some embodiments, the running period of the DRX retransmission timer is (t₃, t₃+t₄] or (t₃, t₃+t₄), wherein t₃ represents the time domain location of the target transmission resource and t₄ represents the duration of the DRX retransmission timer.

Alternatively, the running period of the DRX retransmission timer described above refers to a time period from start to end of a DRX retransmission timer corresponding to a target transmission resource as selected that is determined by the first terminal device based on the duration of the HARQ RTT timer, the duration of the DRX retransmission timer, and the time domain location of the target transmission resource as selected. In some embodiments, the running period of the DRX retransmission timer is (t₅+t₆, t₅+t₆+t₄] or (t₅+t₆, t₅+t₆+t₄), wherein t₅ represents the time domain location corresponding to the PSFCH resource corresponding to the target transmission resource, to represents the duration of the HARQ RTT timer, and t₄ represents the duration of the DRX retransmission timer.

It is noted that the above target transmission resource is any one of the transmission resources selected by the first terminal device in some embodiments. In some embodiments, the target transmission resource is an initial transmission resource (referred to as the initial-transmission resource) or any one of the repeat transmission resources (referred to as the retransmission resource). Furthermore, the duration of the above DRX retransmission timer (i.e., the value of t₄) is configured by a network device, or pre-configured, or specified by a standard, or notified to the first terminal device by other terminal devices (such as the second terminal device), or depends on the implementation of the first terminal device. The duration of the HARQ RTT timer described above (i.e., the value of t₆) is configured by the network device, or pre-configured, or specified by a standard, or notified to the first terminal device by other terminal devices (e.g., the second terminal device), or depends on the implementation of the first terminal device.

In some embodiments, the duration of the DRX inactivity timer, the duration of the DRX retransmission timer, and the duration of the HARQ RTT timer described above are configured duration or instructed duration, i.e., duration prior to the start of timing.

In some embodiments, a value of N above depends on the implementation of the first terminal device, or is configured by a network device, or pre-configured, or specified by a standard.

In some embodiments, the above N is an integer greater than 1.

In some embodiments, the values of N are the same or different for any case of cases 1 to 6 of the first time range.

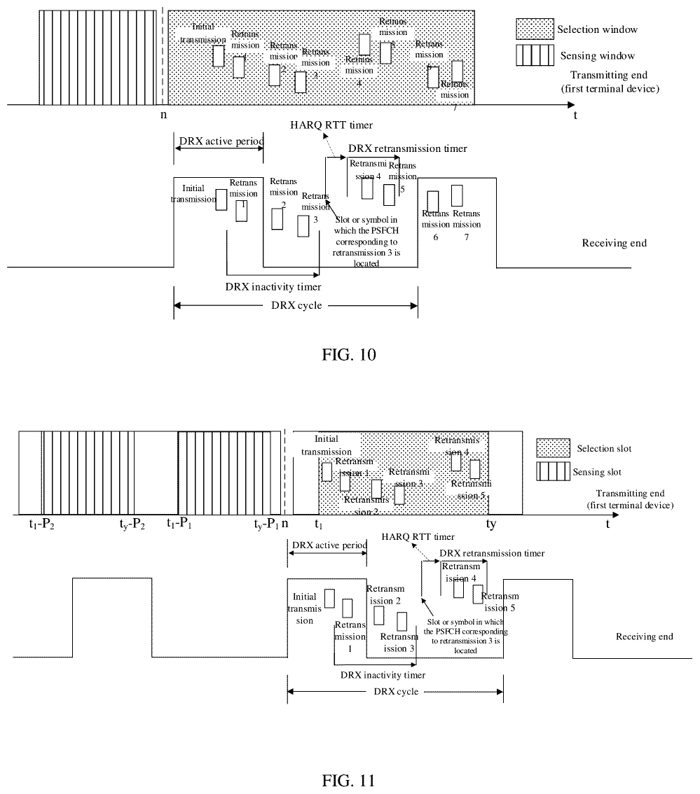

In some embodiments, as shown in FIG. 10, the first terminal device determines a resource sensing window and a resource selection window, and acquires a set of candidate resources by excluding resources in the resource selection window based on the sensing results and and/or non-sensing slots in the resource sensing window. The specific process is referred to as described above and is not repeated herein. The first terminal device randomly selects transmission resources from the set of candidate resources, assuming that N is 2, the first terminal device should ensure that at least 2 transmission resources are selected within the first time range. In some embodiments, in the case that the first time range applies case 1 above, the first terminal device selects four resources, i.e., initial transmission, retransmission 1, retransmission 6, and retransmission 7, from the intersection of the resource selection window and two ON duration periods (i.e., DRX active periods.) Alternately, the first terminal device selects two resources, i.e., initial transmission and retransmission 1, or retransmission 6 and retransmission 7, from the intersection of the resource selection window and one ON duration period (i.e., DRX active period.) In the case that the first time range applies case 3 above, the first terminal device selects three resources, i.e., retransmission 1, retransmission 2, and retransmission 3, from the intersection of the resource selection window and the time range corresponding to the inactivity timer (i.e., the running period of the DRX inactivity timer.) In the case that the first time range applies case 5 above, and the target transmission resource is retransmission 3, the first terminal device selects 2 resources, i.e., retransmission 4 and retransmission 5, from the intersection of the resource selection window and the time range corresponding to the retransmission timer (i.e., the running period of the DRX retransmission timer.)

In another embodiment, as shown in FIG. 11, the first terminal device determines a resource sensing window and a resource selection window, determines Y selection slots t₁ to t_{y} from the resource selection window, and determines corresponding sensing slots in the sensing window based on the selection slots and the set of resource reservation periods configured in the resource pool or a subset thereof. Assuming that the set of resource reservation periods includes resource reservation periods P₁ and P₂, the first terminal device determines the sensing slots as t₁−P₁ to t_{y}−P₁ and t₁−P₂ to t_{y}−P₂. The first terminal device acquires the set of candidate resources by excluding resource in the selection slots at least based on the sensing results at the determined sensing slots and/or the non-sensing slots. The first terminal device randomly selects a transmission resource from the set of candidate resources, and assuming that N is 2, the first terminal device selects at least 2 transmission resources from the first time range. In some embodiments, in the case that the first time range applies case 2 above, the first terminal device selects 2 resources, i.e., initial transmission and retransmission 1, from the intersection of the determined selection slots and one ON duration period (i.e., DRX active period.) In the case that the first time range applies case 4 above, the first terminal device selects 3 resources, i.e., retransmission 1, retransmission 2, and retransmission 3, from the intersection of the determined selection slots and the time range corresponding to the inactivity timer (the running period of the DRX inactivity timer). In the case that the first time range applies case 6 above and the target transmission resource is retransmission 3, the first terminal device selects 2 resources, i.e., retransmission 4 and retransmission 5, from the intersection of the determined selection slot and the time range corresponding to the retransmission timer (i.e., the running period of the DRX Retransmission timer.)

In some exceptions, the first terminal device selects less than N transmission resources within the first time range (including not selecting the transmission resources within the first time range). The exceptions at least include that the first terminal device is unable to select at least N transmission resources within the first time range based on a distribution of remaining resources in the set of candidate resources, for example, a number of slots in which the resources are within the first time range in the set of candidate resources being less than N or a number of resources in the set of candidate resources within the first time range being less than N.

It should be noted that, at the time of resource selection, the above first time range applies one of the above cases in some embodiments, or applies multiple cases at the same time in some embodiments. In some embodiments, in the case that multiple cases are applied simultaneously, at least two of cases 1, 3, and 5 are applied simultaneously, or at least two of cases 2, 4, and 6 are applied simultaneously.

According to the technical solution provided by present embodiments, the transmitting end selects at least N transmission resources within a first time range under the SL communication scenario, the first time range includes the intersection of the link monitoring period at the receiving end and the resource selection period at the transmitting end, thereby increasing the number of transmissions of the transmitting end in the link monitoring period, which makes the probability that the receiving end receives the transmission of the transmitting end higher, further improving the communication reliability.

In some embodiments, the transmitting end increases the number of transmissions during the running period of the DRX activity timer (i.e., the DRX active period), such that the receiving end receives multiple transmissions in the activated state, which increases the reliability of the communication. In some embodiments, the transmitting end increases the number of transmissions during the running period of the DRX inactivity timer and/or the running period of the DRX retransmission timer, thereby reducing the probability that the receiving end enters the sleep state duc to not detecting a transmission, which also increases the communication reliability.

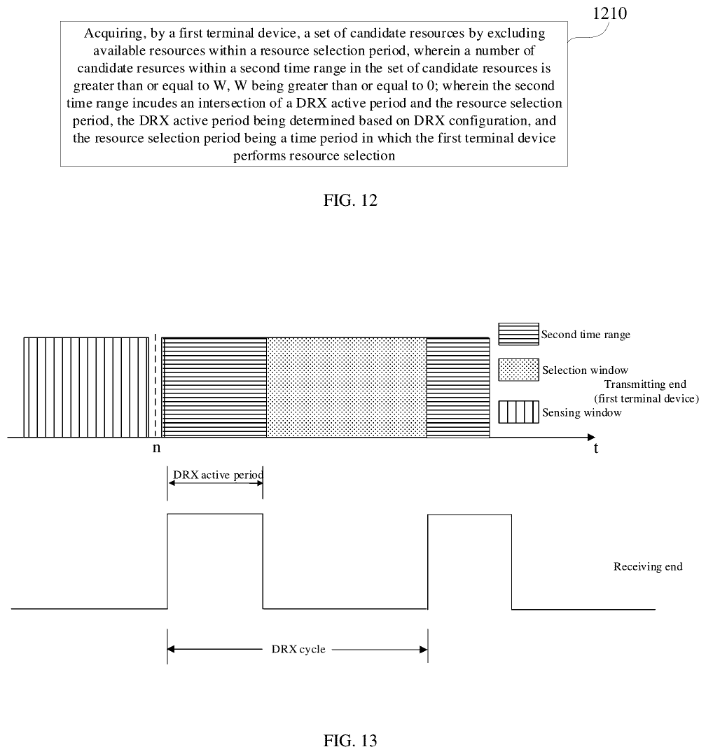

Reference is made to FIG. 12, which illustrates a flowchart of a method for sidelink resource exclusion according to some embodiments of the present disclosure. In some embodiments, the method is applicable to the network architecture shown in FIG. 1. In some embodiments, the method is applicable to any of the terminal devices. In some embodiments, the method includes the following processes.

In process 1210, the first terminal device acquires a set of candidate resources by excluding available resources within a resource selection period, the number of candidate resources within a second time range in the set of candidate resources is greater than or equal to W, W being greater than or equal to 0; wherein the second time range includes an intersection of a DRX active time period and the resource selection period, the DRX active time period being determined based on DRX configuration, and the resource selection period being a time period in which the first terminal device performs resource selection.

The first terminal device is any terminal device. In some embodiments, the first terminal device acts as a transmitting end of the SL communication, determines the set of candidate resources by performing resource exclusion based on the method described in the embodiments prior to transmitting the data to the receiving end, and then transmits the data through a selected transmission resource from the set of candidate resources. In some embodiments, the first terminal device is in SL communication with one other terminal device or with a plurality of other terminal devices, so the receiving end is one terminal device or a plurality of terminal devices. In the embodiments, the terminal device at the receiving end is referred to as the second terminal device for case of illustration, and it should be understood that the number of the second terminal devices is one or more.

The DRX active time period is determined based on the DRX configuration. In some embodiments, the DRX active time period is determined by the first terminal device based on the DRX configuration. The DRX active time period is a period in which a second terminal device configured with DRX is in an activated state (i.e., an active state). In some embodiments, the first terminal device determines the DRX active time period based on DRX configuration, wherein the DRX configuration is specifically configured for one particular second terminal device or is common for a plurality of second terminal devices. In some embodiments, the DRX configuration is configured by a network device, or pre-configured, or specified by a standard, or notified to the first terminal device by other terminal devices (such as the second terminal device), or depends on the implementation of the first terminal device.

In some embodiments, the DRX active time period includes at least one of a DRX active period or a running period of the DRX activity timer. The DRX active period is equivalent to the running period of the DRX activity timer, which is a partial period of the DRX cycle. The second terminal device is in an active state during the DRX active period/the running period of the DRX activity timer to detect the PSCCH and/or PSSCH.

In some embodiments, the resource selection period includes at least one of a whole period corresponding to the resource selection window or a partial period determined from the resource selection window. In the case that the first terminal device performs full sensing (or, in the case that the first terminal device does not perform partial sensing, or by default), the resource selection period is the whole period corresponding to the resource selection window. In the case that the first terminal device performs partial sensing, then the resource selection period is a partial period determined from the resource selection window, e.g., the resource selection period includes at least Y slots within the resource selection window determined by the first terminal device, wherein the at least Y slots are consecutive slots or non-consecutive slots in the time domain.

In some embodiments, the second time range includes any one of the following cases:
case 1: an intersection in the time domain of the DRX active period or the running period of the DRX activity timer and the resource selection window; or
case 2: an intersection in the time domain of the DRX active period or the running period of the DRX activity timer and a partial period (e.g., at least Y slots) determined by the first terminal device from the resource selection window.

In some embodiments, the DRX active period or the running period of the DRX activity timer described above is a time period from start to end of one or more target DRX activity timers determined by the first terminal device based on the DRX configuration. In some embodiments, the target DRX activity timer is determined from one or more candidate DRX activity timers, the candidate DRX activity timer has a running period intersected with the resource selection period.

In some embodiments, the one or more target DRX activity timers described above include all of the candidate DRX activity timers.

In some embodiments, the one or more target DRX activity timers described above include: H candidate DRX activity timers with foremost time domain locations in the one or more candidate DRX activity timers described above, H being a positive integer. The value of H is configured by a network device, or pre-configured, or specified by a standard, or notified to the first terminal device by other terminal devices (such as the second terminal device), or depends on the implementation of the first terminal device. In some embodiments, the DRX active period or the running period of the DRX activity timer is a time period from start to end of one target DRX activity timer determined by the first terminal device based on the DRX configuration, wherein the target DRX activity timer is a candidate DRX activity timer with the most foremost time domain location in the one or more candidate DRX activity timers described above, and this embodiment can be viewed as a special case where H is equal to 1.

In some embodiments, the one or more target DRX activity timers described above include: a candidate DRX activity timer having the longest intersection duration with the resource selection period in the one or more candidate DRX activity timers described above. In some embodiments, the DRX active period or the running period of the DRX activity timer is a time period from start to end of one target DRX activity timer determined by the first terminal device based on the DRX configuration, wherein the target DRX activity timer is a candidate DRX activity timer having the longest intersection duration with the resource selection period in the above one or more candidate DRX activity timers. In some embodiments, in the case that the number of candidate DRX activity timers having the longest intersection duration with the resource selection period is one, then this one candidate DRX activity timer is the target DRX activity timer; and in the case that the number of candidate DRX activity timers having the longest intersection duration with the resource selection period is multiple, then one candidate DRX activity timer is determined from the plurality of candidate DRX activity timers as the target DRX activity timer, such as randomly selecting a candidate DRX activity timer from the plurality of candidate DRX activity timers as the target DRX activity timer, or determining a candidate DRX activity timer with the most foremost time domain location among the plurality of candidate DRX activity timers as the target DRX activity timer.

In some embodiments, a value of W includes any one of the following cases:
case 1: W=R*M₁, wherein M₁ represents the total number of available resources in the resource selection window;
case 2: W=R*M₂, wherein M₂ represents the total number of available resources in a partial period determined by the first terminal device from the resource selection window, e.g. M₂ represents a total number of available resources in at least Y slots determined by the first terminal device from the resource selection window;
case 3: W=R*M₃, wherein M₃ represents the total number of available resources in the second time range;
case 4: W=S*R*M₁, wherein S represents the number of transmission resources that the first terminal device is scheduled to select within the second time range, and M₁ represents the total number of available resources in the resource selection window;
case 5: W=S*R*M₂, wherein S represents the number of transmission resources that the first terminal device is scheduled to select in the second time range, and M₂ represents the total number of available resources in the partial period determined by the first terminal device from the resource selection window; and
case 6: W=S*R*M₃, wherein S represents the number of transmission resources that the first terminal device is scheduled to select in the second time range, and M₃ represents the total number of available resources in the second time range;
wherein R is greater than or equal to 0 and less than or equal to 1. In some embodiments, S in the above cases is instructed to the physical layer by the higher layer. The value of R in the above cases is configured by a network device, or pre-configured, or specified by a standard, or notified to the first terminal device by other terminal devices (e.g., a second terminal device), or depends on the implementation of the first terminal device. In some embodiments, the value of R is related to the resource pool configuration, alternatively, the value of R is related to the priority level of the data to be sent. In some embodiments, the value of R is determined in a manner similar to the manner of determining the value of X described above.

In some embodiments, as shown in FIG. 13, the first terminal device determines a resource sensing window and a resource selection window, and performs resource exclusion on the resource selection window based on the sensing results and/or non-sensing slots at the resource sensing window, the specific process of which is referred to descriptions above and is not repeated herein. The second time range is the intersection in the time domain of the time range corresponding to the ON duration timer (i.e., the running period of the DRX activity timer) and the resource selection window. In FIG. 13, the time range corresponding to the ON duration timer is the time period from start to end of the ON duration timer which is fully intersected with the resource selection window. The first terminal device ensures that upon resource exclusion, the number of remaining candidate resources within the second time range in the set of candidate resources is greater than or equal to W.

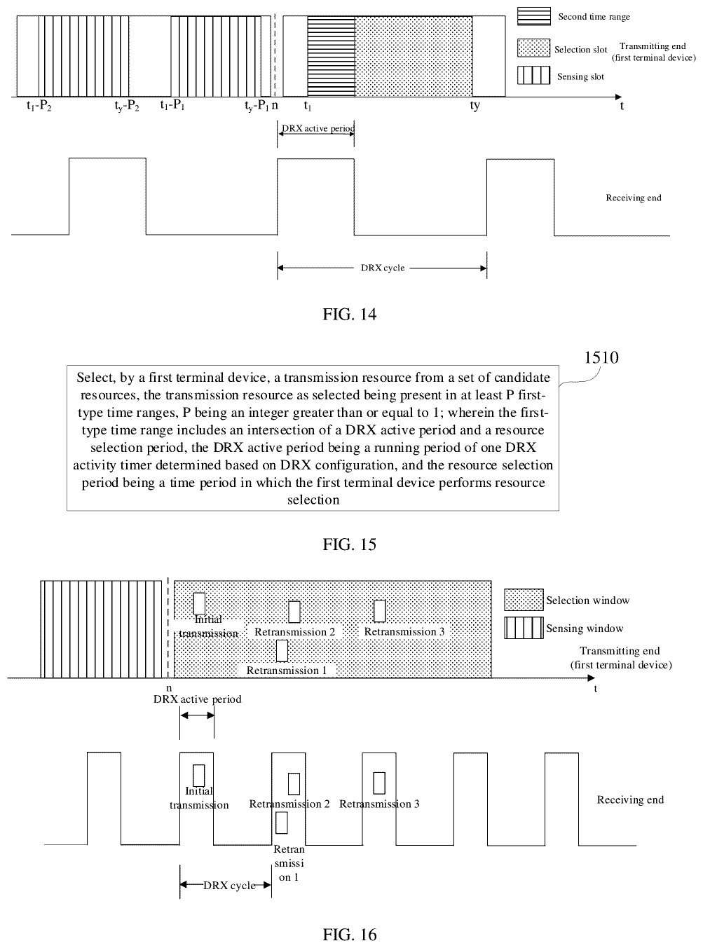

In some embodiments, as shown in FIG. 14, the first terminal device determines a resource sensing window and a resource selection window, determines Y selection slots t₁ to t_{y} from the resource selection window, and determines corresponding sensing slots within the sensing window based on the selection slots and the set of resource reservation periods configured in the resource pool or a subset thereof. Assuming that the set of resource reservation periods includes resource reservation periods P₁ and P₂, the first terminal device determines sensing slots of t₁−P₁ to t_{y}−P₁ and t₁−P₂ to t_{y}−P₂. The first terminal device performs resource exclusion on the selection slots at least based on the sensing results at the determined sensing slots and/or non-sensing slots. The second time range is the intersection in the time domain of the time range corresponding to the ON duration timer (i.e., the running period of the DRX activity timer) and the Y slots determined by the first terminal device. In FIG. 14, the time range corresponding to the ON duration timer is the time period from start to end of the ON duration timer that intersects with the Y slots determined by the first terminal device. The first terminal device ensures that upon resource exclusion, the number of remaining candidate resources within the second time range in the set of candidate resources is greater than or equal to W.

In some embodiments, the first terminal device performs the following processes to exclude the available resources during the resource selection period to acquire the set of candidate resources, so as to ensure that the number of remaining candidate resources within the second time range in the set of candidate resources is greater than or equal to W.

1. An initialized set of available resources is determined, the initialized set of available resources including all available resources within the resource selection period, and the number of resources in the initialized set of available resources is Mₜₒₜₐₗ.

2. A first set of remaining resources is acquired by excluding the available resources in the set of available resources based on a sensing result and/or a non-sensing slot.

3. In the case that the number of resources in the first set of remaining resources is less than Mₜₒₜₐₗ*X or the number of resources in the first set of remaining resources and within the second time range is less than W, a channel quality threshold is increased, then returning to the process of determining the initialized set of available resources.

4. In the case that the number of resources in the first set of remaining resources is greater than or equal to Mₜₒₜₐₗ*X and the number of resources in the first set of remaining resources and within the second time range is greater than or equal to W, the first set of remaining resources is determined as the set of candidate resources.

X is greater than 0 and less than or equal to 1. The method of determining X may be referred to above and is not repeated herein.

In some embodiments, the above process 2 that “a first set of remaining resources is acquired by excluding the available resources in the set of available resources based on a sensing result and/or a non-sensing slot” further includes the following sub-processes.

2-1, a second set of remaining resources is acquired by excluding the available resources in the set of available resources based on the non-sensing slots;

2-2, in the case that the number of resources in the second set of remaining resources is less than Mₜₒₜₐₗ*X or the number of resources in the second set of remaining resources and within the second time range being less than W, a first set of remaining resources is acquired by excluding the available resources in the set of available resources (i.e., the initialized set of available resources in the above process 1) based on the sensing result; and

2-3, in the case that the number of resources in the second set of remaining resources is greater than or equal to Mₜₒₜₐₗ*X and the number of resources in the second set of remaining resources and within the second time range being greater than or equal to W, a first set of remaining resources is acquired by excluding the available resources in the second set of remaining resources based on the sensing result.

In some embodiments, taking the full sensing scenario as an example, the first terminal device performs the following processes for resource exclusion.

1. All the available resources in the resource selection window are initialized into a resource set A, with Mₜₒₜₐₗ representing the number of all available resources in the resource set A.

2. Resource exclusion is performed on resource set A based on the non-sensing slots in the resource sensing window (details can be referred to process 1-1). In some embodiments, whether this process is performed depends on whether the resource pool activates the reservation between TBs. In some embodiments, upon resource exclusion on the resource set A based on the non-sensing slots, in the case that the number of remaining candidate resources in the resource set A is less than Mₜₒₜₐₗ*X or the number of remaining candidate resources in the resource set A and within the second time range is less than W, the resource set A is initialized to include all available resources in the resource selection window, and then process 3 below is performed.

3. Resource exclusion is performed on resource set A based on the first sidelink control information sensed at the resource sensing window (details can refer to process 1-2).

4. In the case that the number of remaining candidate resources in the resource set A is less than Mₜₒₜₐₗ*X or the number of remaining candidate resources in the resource set A and within the second time range is less than W, the RSRP threshold LdB is increased, and process 1 is performed again; otherwise (i.e., the number of remaining candidate resources in the resource set A is greater than or equal to Mₜₒₜₐₗ*X, and the number of remaining candidate resources in the resource set A and within the second time range is greater than or equal to W), the resource exclusion process is ended and the finally acquired resource set A is determined as a set of candidate resources.

In some embodiments, taking partial sensing as an example, the first terminal device performs the following processes for resource exclusion.

1. All available resources in at least Y slots determined by the first terminal device from the resource selection window are initialized into a resource set A, with Mₜₒₜₐₗ representing the number of all available resources in the resource set A.

2. Resource exclusion is performed on the resource set A at least based on the non-sensing slots among the determined sensing slots within the resource sensing window. In some embodiments, whether this process is performed depends on whether the resource pool activates reservation between TBs. In some embodiments, the process is not performed in the case that the first terminal device is configured to perform partial sensing. In some embodiments, upon the exclusion on the resource set A based on the non-sensing slots, in the case that the number of remaining candidate resources in the resource set A is less than Mₜₒₜₐₗ*X or the number of remaining candidate resources in the resource set A and within the second time range is less than W, the resource set A is initialized to include all of the available resources in at least Y slots determined by the first terminal device, and then process 3 below is performed.

3. Resource exclusion is performed on the resource set A at least based on the first sidelink control information sensed at the determined sensing slot within the resource sensing window.

4. In the case that the number of remaining candidate resources in the resource set A is less than Mₜₒₜₐₗ*X or the number of remaining candidate resources in the resource set A and within the second time range is less than W, the RSRP threshold LdB is increased, and process 1 is performed again; otherwise (i.e., the number of remaining candidate resources in the resource set A is greater than or equal to Mₜₒₜₐₗ*X, and the number of remaining candidate resources in the resource set A and within the second time range is greater than or equal to W), the resource exclusion process is ended and the finally acquired resource set A is determined as a set of candidate resource.

In some embodiments, the available resources within the resource selection period refer to all available resources within the resource selection period that belong to the resource pool used by the first terminal device. In some embodiments, in the case that the resource selection period is a whole period corresponding to the resource selection window, the available resources within the resource selection window are all of the available resources within the resource selection window that belong to the resource pool used by the first terminal device. In some embodiments, in the case that the resource selection period is a partial period (e.g., at least Y slots) determined from the resource selection window, the available resources within the partial period (e.g., at least Y slots) are all of the available resources within the partial period (e.g., at least Y slots) belonging to the resource pool used by the first terminal device.

According to the technical solution provided by the present embodiment, there are sufficient candidate resources during the DRX active time period under the SL communication scenario, the transmitting end selects a sufficient number of resources from the DRX active time period, such that the receiving end receives multiple transmissions in the activated state, thereby enhancing the communication reliability.

Reference is made to FIG. 15, which illustrates a flowchart of a method for sidelink resource selection according to some embodiments of the present disclosure. In some embodiments, the method is appliable to the network architecture shown in FIG. 1. In some embodiments, the method is applicable to any of the terminal devices. In some embodiments, the method includes the following process.

Process 1510, the first terminal device selects a transmission resource from the set of candidate resources, the transmission resource as selected being present in at least P first-type time ranges, P being an integer greater than or equal to 1; wherein the first-type time range includes an intersection of a DRX active period and a resource selection period, the DRX active period being a running period of a DRX activity timer determined based on the DRX configuration, and the resource selection period being a time period in which the first terminal device performs resource selection.

In some embodiments, the first terminal device is any terminal device. In some embodiments, the first terminal device acts as a transmitting end of the SL communication, selects a transmission resource based on the method described in the embodiments prior to transmitting the data to the receiving end, and then transmits the data by using the selected transmission resource. In some embodiments, the first terminal device is in SL communication with one other terminal device or is in SL communication with a plurality of other terminal devices. In this way, the receiving end is one terminal device or a plurality of terminal devices. In the embodiments, the terminal device at the receiving end is referred to as a second terminal device for case of illustration, and it should be understood that the number of second terminal devices is one or more.

The DRX active period is an operating period of a DRX activity timer determined based on the DRX configuration. In some embodiments, the DRX active period is a running period of a DRX activity timer determined by the first terminal device based on the DRX configuration. In some embodiments, the DRX active period is a running period of a DRX activity timer of a second terminal device configured with DRX. In some embodiments, the first terminal device determines the DRX active period based on the DRX configuration, wherein the DRX configuration is specifically configured for a particular second terminal device or is common to a plurality of second terminal devices. In some embodiments, the DRX configuration is configured by a network device, or pre-configured, or specified by a standard, or notified to the first terminal device by other terminal devices (e.g., the second terminal device), or depends on the implementation of the first terminal device.

The DRX active period is equivalent to the running period of the DRX activity timer and is a partial period of the DRX cycle. The second terminal device is in an active state during the DRX active period/the running period of the DRX activity timer to detect the PSCCH and/or the PSSCH.

In some embodiments, the resource selection period includes at least one of: a whole period corresponding to the resource selection window or a partial period determined from the resource selection window. In the case that the first terminal device performs full sensing (or, in the case that the first terminal device does not perform partial sensing, or by default), the resource selection period is the whole period corresponding to the resource selection window. In the case that the first terminal device performs partial sensing, the resource selection period is a partial period determined from the resource selection window. In some embodiments, the resource selection period includes at least Y slots determined by the first terminal device from the resource selection window, wherein the at least Y slots are consecutive slots or non-consecutive slots in the time domain.

In some embodiments, the first-type time ranges include any of the following:
case 1: an intersection in the time domain of a DRX active period or a running period of a DRX activity timer and a resource selection window; or
case 2: an intersection in the time domain of the DRX active period or the running period of the DRX activity timer and a partial period (e.g., at least Y slots) determined by the first terminal device from the resource selection window.

In some embodiments, the DRX active period is a time period from start to end of a target DRX activity timer that is determined by the first terminal device based on the DRX configuration, the target DRX activity timer being any DRX activity timer having a running period intersected with the resource selection period.

In some embodiments, the value of P depends on the implementation of the first terminal device, or is configured by a network device, or pre-configured, or specified by a standard.

In some embodiments, P is an integer greater than 1.

In some embodiments, P is less than or equal to U, and U is the total number of first-type time ranges included in the resource selection period.

In some embodiments, the P first-type time ranges described above are P first-type time ranges with the foremost time domain locations in the first-type time ranges included in the resource selection period.

In some embodiments, in the case that P is less than or equal to U, the first terminal device, when selecting a transmission resource, ensures that the selected transmission resource is present for at least P first-type time ranges.

In some embodiments, in the case that a plurality of first-type time ranges exist within the resource selection period (i.e., U is greater than 1), the first terminal device, when selecting a transmission resource, ensures that the selected transmission resource is present in at least P first-type time ranges.

In some exceptions, the first terminal device may not satisfy the above condition (i.e., guaranteeing that the selected transmission resources are present in at least P first-type time ranges) when selecting the transmission resources. The above exceptions include at least (1) P being greater than U; or (2) the first terminal device being unable to select the transmission resource within one or more of the first-type time ranges based on the distribution of the remaining resources in the set of candidate resources, e.g., the resources in the set of candidate resources and within the one or more of the first-type time ranges are all excluded.

In some embodiments, as shown in FIG. 16, the first terminal device determines a resource sensing window and a resource selection window, and acquires a set of candidate resources by excluding the resources in the resource selection window based on the sensing results at the resource sensing window and/or non-sensing slots. The specific process is referred to as described above and is not repeated herein. The first terminal device randomly selects transmission resources from the set of candidate resources, and the first terminal device determines that the total number U of the first-type time ranges is 4. Assuming that P is 3, the first terminal device shall ensure that the selected resources are present in at least 3 of the first-type time ranges. As shown in FIG. 16, the first terminal device, when selecting the transmission resource, ensures that the selected resource is present in first three first-type time ranges in the time domain (the initial transmission is located in a first first-type time range in the time domain, the retransmission 1 and retransmission 2 are located in a second first-type time range in the time domain, and the retransmission 3 is located in a third first-type time range in the time domain).

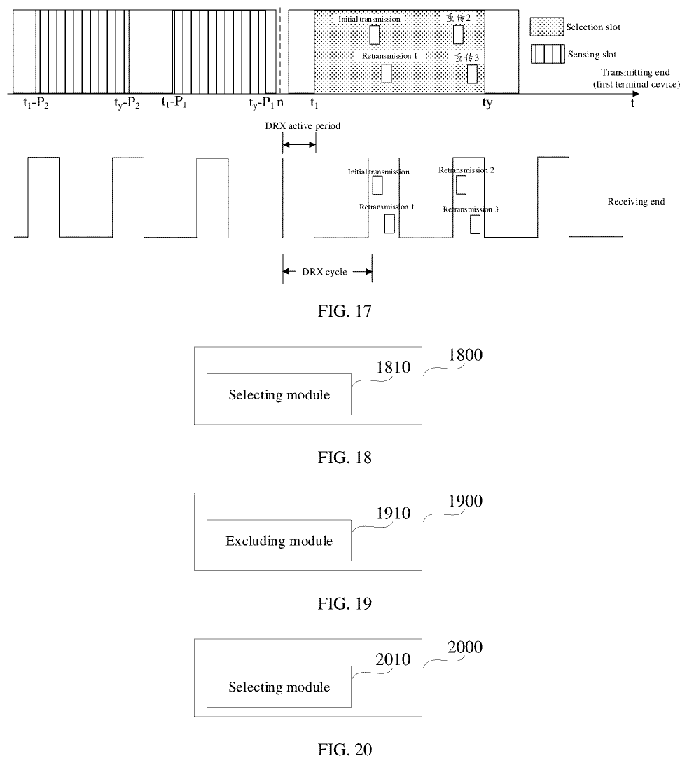

In some other embodiments, as shown in FIG. 17, the first terminal device determines a resource sensing window and a resource selection window, determines Y selection slots t₁ to t_{y} from the resource selection window, and determines corresponding sensing slots within the sensing window based on the selection slots and the set of resource reservation periods configured in the resource pool or a subset thereof. Assuming that the set of resource reservation periods includes resource reservation periods P₁ and P₂, the first terminal device determines the sensing slots as t₁−P₁ to t_{y}−P₁ and t₁−P₂ to t_{y}−P₂. The first terminal device acquires the set of candidate resources by excluding the resources in the selection slots at least based on the sensing results at the determined sensing slots and/or the non-sensing slots. The first terminal device randomly selects transmission resources from the set of candidate resources, and determines the total number U of first-type time ranges to be 2. Assuming that P is 2, the first terminal device shall ensure that the selected resources are present in at least two first-type time ranges. In some embodiments, as shown in FIG. 17, the first terminal device, when selecting the transmission resources, ensures that the selected resources are present in two first-type time ranges (initial transmission and retransmission 1 are present in the first first-type time range in the time domain, and retransmission 1 and retransmission 2 are present in the second first-type time range in the time domain.)

According to the technical solution provided by the present embodiments, the selected resources are present in at least P DRX active periods of the transmitting end under the SL communication scenario, even if the receiving end enters a sleep state due to a packet loss without activating a timer, the receiving end still receives the retransmission of the same data in the following DRX active periods, thereby improving the communication reliability.

The following are the apparatus embodiments of the present disclosure, which can be used to perform the method embodiments of the present disclosure. For details not disclosed in the apparatus embodiments of the present disclosure, please refer to the method embodiments of the present disclosure.

Reference is made to FIG. 18, which is a block diagram of an apparatus for sidelink resource selection according to some embodiments of the present disclosure. The apparatus has a function of achieving the above-described method embodiments, and the function is realized by hardware or by hardware executing corresponding software. In some embodiments, the apparatus is the first terminal device as described above, or is provided in the first terminal device. As shown in FIG. 18, in some embodiments, the apparatus 1800 includes a selecting module 1810.

The selecting module 1810 is configured to select at least N transmission resources within a first time range, N being an integer greater than or equal to 1; wherein the first time range includes an intersection of a link monitoring period and a resource selection period, the link monitoring period being a period determined based on DRX configuration, and the resource selection period being a time period in which the first terminal device performs resource selection.

In some embodiments, the link monitoring period includes at least one of: a DRX active period, a running period of a DRX activity timer, a running period of a DRX inactivity timer, and a running period of a DRX retransmission timer.

In some embodiments, the DRX active period or the running period of the DRX activity timer is a time period from start to end of one or more target DRX activity timers that is determined by the first terminal device based on the DRX configuration.

In some embodiments, the target DRX activity timer is determined from one or more candidate DRX activity timers, the candidate DRX activity timer being a DRX activity timer with a running period intersected with the resource selection period.

In some embodiments, the one or more target DRX activity timers include: all of the candidate DRX activity timers; H candidate DRX activity timers with the foremost time domain locations in the one or more candidate DRX activity timers, H being a positive integer; or a candidate DRX activity timer having a longest intersection duration with the resource selection period in the one or more candidate DRX activity timers.

In some embodiments, the running period of the DRX inactivity timer is a time period from start to end of the DRX inactivity timer that is determined by the first terminal device based on a duration of the DRX inactivity timer and a time domain location of a selected initial transmission resource.

In some embodiments, the running period of the DRX inactivity timer is (t₁, t₁+t₂] or (t₁, t₁+t₂), wherein t₁ represents the time domain location of the initial transmission resource, and t₂ represents the duration of the DRX inactivity timer.

In some embodiments, the running period of the DRX retransmission timer is a time period from start to end of a DRX retransmission timer corresponding to a target transmission resource as selected that is determined by the first terminal device based on a duration of the DRX retransmission timer and a time domain location of the target transmission resource.

In some embodiments, the running period of the DRX retransmission timer is (t₃, t₃+t₄] or (t₃, t₃+t₄), wherein t₃ represents the time domain location of the target transmission resource, and t₄ represents the duration of the DRX retransmission timer.

In some embodiments, the running period of the DRX retransmission timer is a time period from start to end of a DRX retransmission timer corresponding to a target transmission resource as selected that is determined by the first terminal device based on a duration of a HARQ RTT timer, duration of the DRX retransmission timer, and a time domain location of the target transmission resource.

In some embodiments, the running period of the DRX retransmission timer is (t₅+t₆, t₅+t₆+t₄] or (t₅+t₆, t₅+t₆+t₄), wherein t₅ represents a time domain location corresponding to a PSFCH resource that corresponds to the target transmission resource, t₆ represents the duration of the HARQ RTT timer, and t₄ represents the duration of the DRX retransmission timer.

In some embodiments, the resource selection period includes at least one of: a whole period corresponding to a resource selection window or a partial period determined from the resource selection window.

In some embodiments, a value of N depends on implementation of the first terminal device, or is configured by a network device, or pre-configured, or specified by a standard.

According to the technical solution provided by present embodiments, the transmitting end selects at least N transmission resources within a first time range under the SL communication scenario, the first time range includes the intersection of the link monitoring period at the receiving end and the resource selection period at the transmitting end, thereby increasing the number of transmissions of the transmitting end in the link monitoring period, which makes the probability that the receiving end receives the transmission of the transmitting end higher, further improving the communication reliability.

Reference is made to FIG. 19, which is a block diagram of an apparatus for sidelink resource exclusion according to some embodiments of the present disclosure. The apparatus has a function for achieving the above-described method embodiments, and the function is achieved by hardware or by hardware executing corresponding software. In some embodiments, the apparatus is the first terminal device as described above, or is provided in the first terminal device. As shown in FIG. 19, in some embodiments, the apparatus 1900 includes an excluding module 1910.

The excluding module 1910 is configured to acquire a set of candidate resources by excluding available resources within a resource selection period, a number of candidate resources within a second time range in the set of candidate resources is greater than or equal to W, W being greater than or equal to 0; wherein the second time range includes an intersection of a discontinuous reception (DRX) active time period and the resource selection period, the DRX active time period being determined based on DRX configuration, and the resource selection period being a time period in which the first terminal device performs resource selection.

In some embodiments, the DRX active time period includes at least one of: a DRX active period or a running period of a DRX activity timer.

In some embodiments, the DRX active period or the running period of the DRX activity timer is a time period from start to end of one or more target DRX activity timers determined by the first terminal device based on the DRX configuration.

In some embodiments, the target DRX activity timer is determined from one or more candidate DRX activity timers, the candidate DRX activity timer having a running period intersected with the resource selection period.

In some embodiments, the one or more target DRX activity timers include: all of the one or more candidate DRX activity timers; H candidate DRX activity timers with the foremost time domain locations in the one or more candidate DRX activity timers, H being a positive integer; or a candidate DRX activity timer having a longest intersection duration with the resource selection period in the one or more candidate DRX activity timers.

In some embodiments, the resource selection period includes at least one of: a whole period corresponding to a resource selection window or a partial period determined from the resource selection window.

In some embodiments, W=R*M₁, wherein M₁ represents the total number of available resources in a resource selection window; or
W=R*M₂, wherein M₂ represents the total number of available resources in a partial period determined by the first terminal device from the resource selection window; or
W=R*M₃, wherein M₃ represents the total number of available resources in the second time range; or
W=S*R*M₁, wherein S represents the number of transmission resources that the first terminal device is scheduled to select within the second time range, and M₁ represents the total number of available resources in the resource selection window; or
W=S*R*M₂, wherein S represents the number of transmission resources that the first terminal device is scheduled to select within the second time range, and M₂ represents the total number of available resources in the partial period determined by the first terminal device from the resource selection window; or
W=S*R*M₃, wherein S represents the number of transmission resources that the first terminal device is scheduled to select within the second time range, and M₃ represents the total number of available resources in the second time range;
wherein R is greater than or equal to 0 and less than or equal to 1.

In some embodiments, a value of R depends on implementation of the first terminal device, or is configured by a network device, or pre-configured, or specified by a standard.

In some embodiments, a value of R is configured by a network device, or pre-configured, or specified by a standard, or notified to the first terminal device by other terminal devices, or depends on the implementation of the first terminal device.

In some embodiments, the excluding module is configured to:
determine an initialized set of available resources, wherein the initialized set of available resources includes all available resources within the resource selection period, and a number of resources in the initialized set of available resources is Mₜₒₜₐₗ;
acquire a first set of remaining resources by excluding the available resources in the set of available resources based on a sensing result and/or a non-sensing slot;
in the case that the number of resources in the first set of remaining resources is less than Mₜₒₜₐₗ*X or the number of resources in the first set of remaining resources and within the second time range is less than W, increase a channel quality threshold and then return to determining the initialized set of available resources; and
in the case that the number of resources in the first set of remaining resources is greater than or equal to Mₜₒₜₐₗ*X and the number of resources in the first set of remaining resources and within the second time range is greater than or equal to W, determine the first set of remaining resources as the set of candidate resources;
wherein X is greater than 0 and less than or equal to 1.

According to the technical solution provided by the present embodiment, there are sufficient candidate resources during the DRX active time period under the SL communication scenario, the transmitting end selects a sufficient number of resources from the DRX active time period, such that the receiving end receives multiple transmissions in the activated state, thereby enhancing the communication reliability.

Reference is made to FIG. 20, which is a block diagram of an apparatus for sidelink resource selection according to some embodiments of the present disclosure. The apparatus has a function for achieving the above-described method embodiments, and the function is achieved by hardware or by hardware executing corresponding software. In some embodiments, the apparatus is the first terminal device as described above, or is provided in the first terminal device. As shown in FIG. 20, in some embodiments, the device 2000 includes a selecting module 2010.

The selecting module 2010 is configured to select a transmission resource from a set of candidate resources, the transmission resource as selected being present in at least P first-type time ranges, P being an integer greater than or equal to 1; wherein the first-type time range includes an intersection of a discontinuous reception DRX active period and a resource selection period, the DRX active period being a running period of one DRX activity timer determined based on DRX configuration, and the resource selection period being a time period in which the first terminal device performs resource selection.

In some embodiments, the DRX active period is a time period from start to end of one target DRX activity timer that is determined by the first terminal device based on the DRX configuration, the target DRX activity timer being any DRX activity timer having a running period intersected with the resource selection period.

In some embodiments, the resource selection period includes at least one of: a whole period corresponding to a resource selection window or a partial period determined from the resource selection window.

In some embodiments, a value of P depends on the implementation of the first terminal device, or is configured by a network device, or pre-configured, or specified by a standard.

According to the technical solution provided by the present embodiments, the selected resources are present in at least P DRX active periods of the transmitting end under the SL communication scenario, even if the receiving end enters a sleep state due to a packet loss without activating a timer, the receiving end still receives the retransmission of the same data in the following DRX active periods, thereby improving the communication reliability.

It should be noted that in the above embodiments, the apparatus is exemplarily divided into multiple functional modules as described above to achieve the functions of the apparatus, and in actual application, the above-described functions can be assigned to be accomplished by different functional modules according to the actual needs, i.e., the internal structure of the device is divided into different functional modules in order to accomplish all or part of the above-described functions.

With respect to the apparatuses in the above embodiments, the specific manner in which each module performs an operation is described in detail in related method embodiments, and is not described in detail herein.

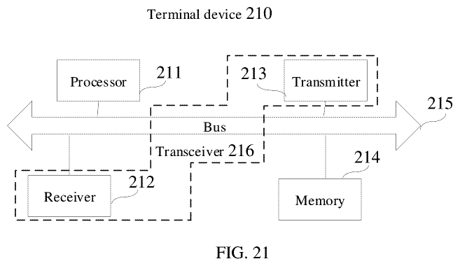

Reference is made to FIG. 21, which is a structural schematic diagram of a terminal device 210 according to some embodiments of the present disclosure. In some embodiments, the terminal device is a first terminal device in the above embodiment, and configured to perform the method for sidelink resource selection or sidelink resource exclusion as described above. In some embodiments, the terminal device 210 includes a processor 211, a receiver 212, a transmitter 213, a memory 214, and a bus 215.

The processor 211 includes one or more processing cores, and the processor 211 performs various functional applications as well as information processing by running software programs as well as modules.

In some embodiments, the receiver 212 and transmitter 213 are implemented as a transceiver 216. In some embodiments, the transceiver 216 is a communication chip.

The memory 214 is connected to the processor 211 via a bus 215.

In some embodiments, the memory 214 is used to store a computer program, and the processor 211 is configured to execute the computer program to perform the various processes performed by the first terminal device in the method embodiments described above.

In addition, in some embodiments, the memory 214 is implemented by any type of volatile or non-volatile storage device, or a combination thereof, including but not limited to: random-access memory (RAM) and read-only memory (ROM), erasable programmable read-only memory (EPROM), electrically erasable programmable read-only memory (EEPROM), flash memory or other solid-state storage technologies, compact disc read-only memory (CD-ROM), digital video disc (DVD) or other optical storage, cassette, tapes, disk storage or other magnetic storage devices.

In some embodiments, the processor 211 is configured to select at least N transmission resources from a first time range, N being an integer greater than or equal to 1; wherein the first time range includes an intersection of a link monitoring period and a resource selection period, the link monitoring period being a period determined by the first terminal device based on DRX configuration, and the resource selection period being a time period in which the first terminal device performs resource selection.

In some embodiments, the processor 211 is configured to acquire a set of candidate resources by excluding available resources within a resource selection period, a number of candidate resources within a second time range in the set of candidate resources is greater than or equal to W, W being greater than or equal to 0; wherein the second time range includes an intersection of a DRX active time period and the resource selection period, the DRX active time period being determined by the first terminal device based on DRX configuration, and the resource selection period being a time period in which the first terminal device performs resource selection.

In some embodiments, the processor 211 is configured to select a transmission resource from a set of candidate resources, the selected transmission resource being present in at least P first-type time ranges, P being an integer greater than or equal to 1; wherein the first-type time range includes an intersection of a DRX active period and a resource selection period, the DRX active period being a running period of one DRX activity timer determined by the first terminal device based on DRX configuration, and the resource selection period being a time period in which the first terminal device performs resource selection.

For details not described in detail in the above embodiments, reference is made to the description in the method embodiments above, which is not repeated herein.

Embodiments of the present disclosure further provide a non-transitory computer-readable storage medium. The storage medium stores a computer program. The computer program, when loaded and run by a processor of a terminal device, causes the terminal device to perform the above methods for sidelink resource selection or sidelink resource exclusion.

In some embodiments, the computer-readable storage medium includes a read-only memory (ROM), a random-access memory (RAM), an solid state drives (SSD), or a compact disc, etc. In some embodiments, the random access memory includes resistance random access memory (ReRAM) and dynamic random access memory (DRAM).

Embodiments of the present disclosure further provide a chip, the chip including a programmable logic circuit and/or program instructions. The chip, when running on a terminal device, causes the terminal device to perform the method for sidelink resource selection or sidelink resource exclusion as described above.

Embodiments of the present disclosure further provide a computer program product or computer program, the computer program product or computer program including one or more computer instructions, the computer instructions being stored in a computer-readable storage medium.

The one or more computer instructions, when loaded from the computer-readable storage medium and run by a processor of a terminal device, cause the terminal device to perform the method for sidelink resource selection or sidelink resource exclusion as described above.

It should be understood that the “instruct” in the embodiments of the present disclosure includes the meanings of direct instruction, indirect instruction, or having an associated relationship. In some embodiments, A instructing B means that A directly instructs B, such as B can be accessed through A; or that A indirectly instructs B, such as A instructs C, and B can be accessed through C; or that there is an associated relationship between A and B.

In the description of embodiments of the present disclosure, the term “corresponding” indicates a direct or indirect corresponding relationship between two elements, or an associated relationship between the two elements, or a relationship of instructing and being instructed, configuring and being configured, and the like.

In this disclosure, the term “multiple” is used to refer to two or more. The term “and/or” describes the association relationship of the associated objects, indicating that there are three kinds of relationships. For example, the phrase “A and/or B” means (A), (B), or (A and B). The symbol “/” generally indicates an “or” relationship between the associated objects.

In addition, the numbering of the processes described herein only exemplarily shows a possible execution sequence of the processes, and in some other embodiments, the above processes are executed without following the numbering sequence, such as two differently numbered processes being executed at the same time, or two differently numbered processes being executed in the order opposite to the order illustrated in figure, which is not limited in the embodiments of the present disclosure.

It should be appreciated by those skilled in the art that, in one or more of the above embodiments, the functions described in the embodiments of the present disclosure can be implemented using hardware, software, firmware, or any combination thereof. In the case of implementing by software, the functions are stored in a computer-readable medium or transmitted as one or more instructions or codes on the computer-readable medium. The computer-readable media include computer storage media and communication media, wherein the communication media includes any medium that facilitates the transmission of a computer program from one location to another. The storage medium includes any usable medium to which a general-purpose or specialized computer has access.

The foregoing are only exemplary embodiments of this disclosure and are not intended to limit this disclosure, and any modifications, equivalent substitutions, improvements, etc., made within the concept and principles of the disclosure shall be included in the scope of protection of the disclosure.

The invention claimed is:

1. A method for sidelink resource selection, applicable to a first terminal device, the method comprising:
selecting at least N transmission resources within a first time range, N being an integer greater than or equal to 1;
wherein the first time range comprises an intersection of a link monitoring period and a resource selection period, the link monitoring period being determined based on discontinuous reception (DRX) configuration, and the resource selection period being a time period in which the first terminal device performs resource selection.

2. The method according to claim 1, wherein the link monitoring period comprises at least one of: a DRX active period, a running period of a DRX activity timer, a running period of a DRX inactivity timer, or a running period of a DRX retransmission timer.

3-5. (canceled)

6. The method according to claim 2, wherein the running period of the DRX inactivity timer is a time period from start to end of the DRX inactivity timer that is determined by the first terminal device based on a duration of the DRX inactivity timer and a time domain location of an initial transmission resource as selected.

7. The method according to claim 6, wherein the running period of the DRX inactivity timer is (t₁, t₁+t₂] or (t₁, t₁+t₂), wherein t₁ represents the time domain location of the initial transmission resource, and t₂ represents the duration of the DRX inactivity timer.

8. The method according to claim 2, wherein the running period of the DRX retransmission timer is a time period from start to end of a DRX retransmission timer corresponding to a target transmission resource as selected that is determined by the first terminal device based on a duration of the DRX retransmission timer and a time domain location of the target transmission resource.

9. The method according to claim 8, wherein the running period of the DRX retransmission timer is (t₃, t₃+t₄] or (t₃, t₃+t₄), wherein t₃ represents the time domain location of the target transmission resource, and t₄ represents the duration of the DRX retransmission timer.

10. The method according to claim 2, wherein the running period of the DRX retransmission timer is a time period from start to end of a DRX retransmission timer corresponding to a target transmission resource as selected that is determined by the first terminal device based on a duration of a hybrid automatic repeat request (HARQ) round-trip time (RTT) timer, a duration of the DRX retransmission timer, and a time domain location of the target transmission resource as selected.

11. The method according to claim 10, wherein the running period of the DRX retransmission timer is (t₅+t₆, t₅+t₆+t₄] or (t₅+t₆, t₅+t₆+t₄), wherein t₅ represents a time domain location of a physical sidelink feedback channel (PSFCH) resource corresponding to the target transmission resource, to represents the duration of the HARQ RTT timer, and t₄ represents the duration of the DRX retransmission timer.

12. The method according to claim 1, wherein the resource selection period comprises at least one of: a whole period corresponding to a resource selection window or a partial period determined from the resource selection window.

13. The method according to claim 1, wherein a value of N depends on implementation of the first terminal device, or is configured by a network device, or pre-configured, or specified by a standard.

14. A method for sidelink resource exclusion, applicable to a first terminal device, the method comprising:
acquiring a set of candidate resources by excluding available resources within a resource selection period, wherein a number of candidate resources within a second time range in the set of candidate resources is greater than or equal to W, W being greater than or equal to 0;
wherein the second time range comprises an intersection of a discontinuous reception (DRX) active time period and the resource selection period, the DRX active time period being determined based on DRX configuration, and the resource selection period being a time period in which the first terminal device performs resource selection.

15. The method according to claim 14, wherein the DRX active time period comprises a running period of a DRX activity timer.

16-18. (canceled)

19. The method according to claim 14, wherein the resource selection period comprises at least one of: a whole period corresponding to a resource selection window or a partial period determined from the resource selection window.

20-54. (canceled)

55. A terminal device, comprising: a processor and a memory configured to store at least one computer program, wherein the processor, when loading and executing the at least one computer program, is caused to perform:
selecting at least N transmission resources within a first time range, N being an integer greater than or equal to 1;
wherein the first time range comprises an intersection of a link monitoring period and a resource selection period, the link monitoring period being determined based on discontinuous reception (DRX) configuration, and the resource selection period being a time period in which the first terminal device performs resource selection.

56. A non-transitory computer-readable storage medium storing at least one computer program, wherein the at least one computer program, when loaded and run by a processor, causes the processor to perform the method as defined in claim 1.

57. A chip, comprising: programmable logic circuitry and/or one or more program instructions, wherein the chip, when running on a terminal device, causes the terminal device to perform the method as defined in claim 1.

58. (canceled)

59. The terminal device according to claim 55, wherein the link monitoring period comprises at least one of: a running period of a DRX activity timer, a running period of a DRX inactivity timer, or a running period of a DRX retransmission timer.

60. The terminal device according to claim 59, wherein the running period of the DRX inactivity timer is a time period from start to end of the DRX inactivity timer that is determined by the first terminal device based on a duration of the DRX inactivity timer and a time domain location of an initial transmission resource as selected.

61. The terminal device according to claim 59, wherein the running period of the DRX retransmission timer is a time period from start to end of a DRX retransmission timer corresponding to a target transmission resource as selected that is determined by the first terminal device based on a duration of the DRX retransmission timer and a time domain location of the target transmission resource.

62. The terminal device according to claim 59, wherein the running period of the DRX retransmission timer is a time period from start to end of a DRX retransmission timer corresponding to a target transmission resource as selected that is determined by the first terminal device based on a duration of a hybrid automatic repeat request (HARQ) round-trip time (RTT) timer, a duration of the DRX retransmission timer, and a time domain location of the target transmission resource as selected.
